(19) United States
(12) Patent Application Publication
(10) Pub. No.: US 2025/0315820 A1
(43) Pub. Date: Oct. 9, 2025

(54) CONFIDENTIAL NON-FUNGIBLE TOKENS (NFTS)

(71) Applicant: Mysten Labs, Inc., Palo Alto, CA (US)

(72) Inventors: Foteini Baldimtsi, Fairfax, VA (US); Konstantinos Chalkias, Dubai (AE); Yan Ji, New York, NY (US); Arnab Roy, Freemont, CA (US); Joy Wang, Brooklyn, NY (US)

(73) Assignee: Mysten Labs, Inc., Palo Alto, CA (US)

(21) Appl. No.: 19/172,220

(22) Filed: Apr. 7, 2025

Related U.S. Application Data
(60) Provisional application No. 63/631,727, filed on Apr. 9, 2024.

(51) Int. Cl. G06Q 20/38

(52) U.S. Cl. CPC G06Q 20/3823; G06Q 20/3827; G06Q 20/3829; G06Q 20/389

(57) ABSTRACT

Disclosed are systems, apparatuses, processes, and computer-readable media for confidential NFTs. For example, an example of a process for transferring ownership of an at least partially obfuscated NFT can include at least partially encrypting an NFT. The process can further include associating the at least partially obfuscated NFT with a smart contract that defines conditions under which the at least partially obfuscated NFT will be transferred to a buyer with a decryption key to decrypt the at least partially obfuscated NFT. The conditions ensure that a clear portion of the at least partially obfuscated NFT is part of the at least partially obfuscated NFT. The process includes receiving a request from a buyer to purchase the at least partially obfuscated NFT. Further, the process can include executing, based on receiving the request, the smart contract to complete the transaction based on the conditions of the smart contract.

### CROSS-REFERENCE TO RELATED APPLICATION

This application claims the benefit of, and priority to, U.S. Provisional Application No. 63/631,727, filed Apr. 9, 2024, which is hereby incorporated by reference, in its entirety and for all purposes.

### FIELD

The present disclosure generally relates to non-fungible tokens (NFTs). For example, aspects of the present disclosure relate to confidential NFTs.

### BACKGROUND

An NFT is a unique digital asset that represents ownership or proof of authenticity of a specific item or piece of content using blockchain technology. NFTs are typically sold through online marketplaces and auctions, where buyers bid on or purchase these digital assets using cryptocurrencies. In the digital era, NFTs have gained prominence as a tool for establishing ownership and authenticity of digital assets. However, the openness of traditional NFTs on public blockchain networks often falls short in addressing privacy, security, and exclusivity concerns.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1A and FIG. 1B illustrate example systems, in accordance with some aspects of the present technology.

FIG. 2 illustrates an example high-level method for transferring ownership of an at least partially obfuscated NFT, in accordance with some aspects of the present technology.

FIG. 3 illustrates an example high-level method for transferring ownership of an encrypted NFT using a zero-knowledge proof to prove the authenticity of the encrypted NFT, in accordance with some aspects of the present technology.

FIG. 4 illustrates a routine 400 for transferring ownership of an encrypted NFT, in accordance with some aspects of the present technology.

FIG. 5 illustrates an example blockchain transaction process 500, in accordance with some aspects of the present technology.

FIG. 6 illustrates an embodiment of an irreversible transaction blockchain 600, in accordance with some aspects of the present technology.

FIG. 7A is a diagram illustrating an example of a workflow for transferring ownership of an encrypted NFT with a partial reveal, where a marketplace encrypts the NFT with a partial reveal, in accordance with some aspects of the present technology.

FIG. 7B is a diagram illustrating an example of a workflow for transferring ownership of an encrypted NFT with a partial reveal, where a creator encrypts the NFT with a partial reveal, in accordance with some aspects of the present technology.

FIG. 8 illustrates an example process 800 for transferring ownership of an encrypted NFT (without a partial reveal) using a zero-knowledge proof to prove the authenticity of the encrypted NFT, in accordance with some aspects of the present technology.

FIG. 9 illustrates examples 900 of partial reveals of an NFT with different degrees of obfuscation, in accordance with some aspects of the present technology.

FIG. 10 illustrates an example of a process 1000 for generating an NFT with a partial reveal, in accordance with some aspects of the present technology.

FIG. 11 illustrates an example of a process 1100 for a buyer to prove and purchase an NFT with a partial reveal, in accordance with some aspects of the present technology.

FIG. 12 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, an NFT is a unique digital asset that represents ownership or proof of authenticity of a specific item or piece of content using blockchain technology. NFTs are typically sold through online marketplaces and auctions, where buyers bid on or purchase these digital assets using cryptocurrencies. NFTs typically contain references to digital files, such as artworks, photos, videos, and audio. Because NFTs are uniquely identifiable, NFTs differ from cryptocurrencies, which are fungible. NFTs function like cryptographic tokens, but unlike cryptographic tokens, NFTs are not usually mutually interchangeable, so they are considered to be non-fungible.

NFTs are unique digital identifiers that are recorded on a blockchain. The ownership of an NFT is recorded on a blockchain and can be transferred by the owner (e.g., a seller) to a buyer, allowing NFTs to be sold and traded. A blockchain is a distributed ledger with a growing list of records (e.g., in the form of blocks) that are securely linked together via cryptographic hashes.

In the digital era, NFTs have gained prominence as a tool for establishing ownership and authenticity of digital assets. However, the openness of traditional NFTs on public blockchain networks can often fall short in addressing privacy, security, and exclusivity concerns.

For example, given that NFTs are digital tokens, the actual purchase (e.g., exchange of funds for an NFT) should be handled with special care (e.g., where the exchange should occur in a fair manner resulting in a fair exchange). This idea of a “fair exchange” is well understood in the related field, and it has been shown that a fair exchange is not feasible unless a reliable third party is involved with the transaction. The use of blockchain technology with smart contracts can replace the need for a reliable intermediary, ensuring a fair exchange where, simultaneously, the ownership of an NFT is transferred from a seller to a buyer and a payment is made from a buyer to a seller.

Currently, a number of different NFT marketplaces exist (e.g., OpenSea, HyperSpace, Magic Eden etc.), which sell NFTs either for a fixed price or through an auction. An on-chain (e.g., blockchain) marketplace usually implements a smart contract that allows offerors (e.g., sellers) to create listings. An offeror can give approvals to a fulfiller (e.g., intermediaries) for the listings, then the items (e.g., for a consideration paid by a recipient) can be transferred from the fulfiller to a recipient (e.g., a buyer). However, most of these existing NFT marketplaces do not offer privacy features, meaning that buyer and offeror's addresses, orderbook details, and the asset itself are revealed on-chain upon minting of the NFT. With the NFT details publicly viewable, it is very easy to duplicate the underlying asset since it is fully accessible by anyone.

For one-of-a-kind digital collectibles, this compromised privacy can lead to a decreased value for ownership of NFTs and can be harmful for the NFT marketplace. In traditional marketplaces, it is not possible to offer “sneak peaks” of the NFT that partially reveals features of the NFT to a buyer before ownership of that NFT by the buyer. Furthermore, for NFTs representing real world assets, such as real estate and luxury goods, privacy can be a requirement where certain personal and/or property information are too sensitive to be revealed on-chain. The lack of privacy can also lead to theft, as NFT ownership does not prevent unauthorized copying of linked digital assets.

The concept of encrypted NFTs, where an NFT's content remains concealed until after it is purchased by a buyer, can address the issues previously mentioned. Encrypted NFTs can offer the potential for NFT creators (e.g., sellers) to be able to retain control over their work (e.g., created NFTs) and to reveal their work exclusively to a buyer, ensuring that the digital content remains hidden from the public eye, thereby reducing the risk of any unauthorized copying or misuse of their work.

Currently, one existing approach (e.g., employed by Secret Network (SCRT)) supports encrypted NFTs by leveraging private computation on a protocol level using trusted execution environments (TEEs). At a high level, validators are employed to process transactions for the NFTs. Data is only decrypted inside a TEE of a specific validator. Computations following any transaction (e.g., established by a smart contract) are performed in the TEE using the decrypted data, and the output is encrypted (e.g., to produce an encrypted NFT). To allow viewing (e.g., by a buyer) of the private properties of an NFT, an owner can issue a permit to the buyer for viewing access of the encrypted NFT. By verifying the permit and a user's public key, the smart contract can return the decrypted data (e.g., the decrypted NFT) to the buyer as requested. The assumption of privacy of this approach relies on the security of the TEEs. This approach also requires blockchains to support it on the protocol level. A solution without requiring the use of TEEs is desirable.

There is an existing solution (e.g., referred to as hierarchical identity based encryption with constant size ciphertext) that does not require the use of TEEs. This solution proposes using a protocol for encrypted NFTs that relies on threshold encryption and secret sharing. However, this solution has disadvantages including the need for communication and coordination across all validators during an initial setup phase (e.g., necessary for the threshold key generation phase), and the need for a seller to communicate information with each individual validator in order to setup an encrypted NFT for sale.

As such, improved systems and techniques for confidential NFTs that improve privacy, security, and exclusivity concerns (without requiring the use of TEEs) can be beneficial.

In one or more aspects of the present disclosure, systems, apparatuses, methods (also referred to as processes), and computer-readable media (collectively referred to herein as “systems and techniques”) are described herein that provide solutions for confidential NFTs. In one or more examples, the systems and techniques provide solutions for encrypted NFTs with a partial reveal. In one or more examples, the systems and techniques provide protocols for encrypted NFTs that do not require the use of specialized hardware (e.g., TEEs), and may be based only on the use of cryptographic primitives.

In some examples, the present technology of the systems and techniques pertains to transferring a NFT in a transaction that prevents the NFT from being fully revealed to a potential buyer, until a transaction transferring rights in the NFT has occurred. The present technology of the systems and techniques substantially reduces the possibility that a potential buyer or other unauthorized party can make an unauthorized copy of the NFT without receiving the rights in the NFT. At the same time, the present technology of the systems and techniques provides protections and assurances to a potential buyer that the seller of the NFT does, in fact, possess the NFT. The present technology of the systems and techniques encrypts the NFT such that the NFT is not exposed to the potential buyer, or is not exposed in full. As such, the potential buyer may not view the whole contents of the NFT prior to completing the transaction. In one or more examples, in order to give assurances to the potential buyer, cryptographic proofs can be used to prove that the seller of the NFT possesses the NFT and the decryption key(s) needed to decrypt the NFT.

In one or more examples, the systems and techniques provide encrypted-NFT (E-NFT) protocols that assume the involvement of the seller during the selling process. In existing approaches (as previously discussed), it is assumed that the seller will encrypt their NFT, post the NFT on a chain, and then, via the execution of a smart contract (e.g., which potentially runs an auction), receive payment from the buyer for the NFT. Upon receiving payment, the buyer will receive the hidden NFT without any further involvement from the seller. This assumption creates unnecessary complications for the existing approaches. Instead, as proposed by the systems and techniques, by assuming that the seller is eventually informed about the buyer's information, the protocols can be much more effective.

In some examples, the systems and techniques employ an approach using encrypted-NFTs (E-NFTs) that seamlessly integrates encryption with NFT technology to not only enhance security and privacy, but to also enforce exclusivity of digital assets. By incorporating encryption to cloak NFTs (e.g., to produce E-NFTs), E-NFTs can ensure that detailed content of the digital asset is exclusively accessible only to the NFT owner. This level of exclusivity can elevate the value and uniqueness of the digital asset, thereby making the digital asset appealing for premium markets and collectors. The systems and techniques provide in-depth analysis and description of the proposed E-NET framework, emphasizing how encryption can be leveraged to create a more secure, private, and exclusive digital asset environment.

In one or more examples, the systems and techniques can provide the benefit of providing for diverse applications of E-NFTs in various sectors, including digital art, intellectual property, and sensitive data handling, demonstrating how E-NFTs can revolutionize the concept of digital ownership. As such, the use of E-NFTs can significantly advance the functionalities of traditional NFTs, leading to increased trust and security, and a new level of exclusivity in the digital asset marketplace.

Additional aspects of the present disclosure are described in more detail below.

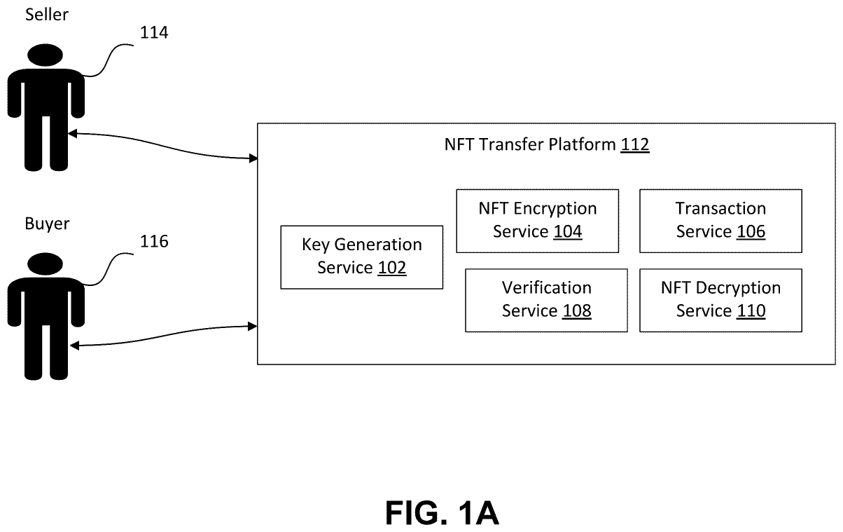

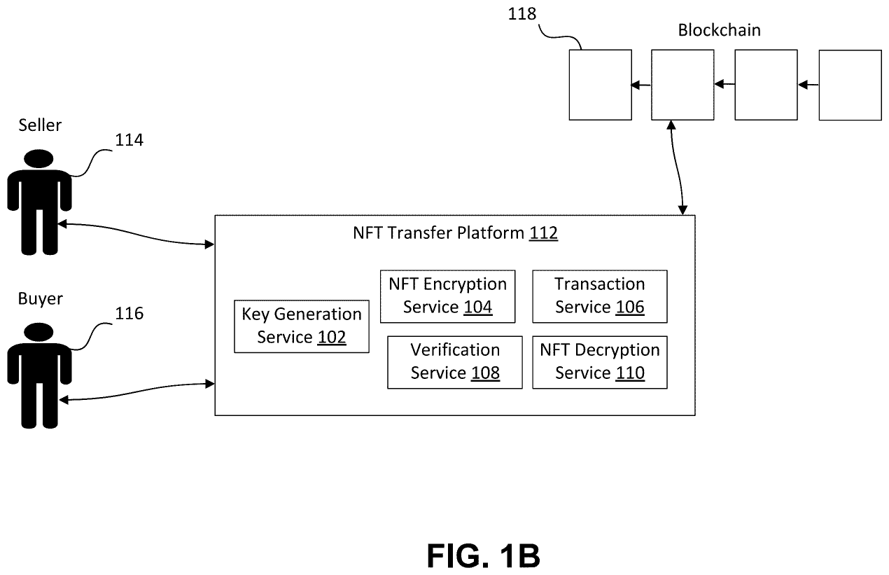

FIG. 1A and FIG. 1B illustrate example systems, in accordance with some aspects of the present technology. In FIGS. 1A and 1B, seller 114 can interact with NFT transfer platform 112 to provide an NFT for transfer to a buyer 116. The seller 114 can interact with a key generation service 102 at the NFT transfer platform 112 to establish one or more key pairs (e.g., seller private key and seller public key). An NFT encryption service 104 can use these keys in one or more processes for encrypting the NFT.

Transaction service 106 can be used to create a smart contract (e.g., a program that ensures conditions of a transaction are carried out and directs the outcome of the transaction upon a successful completion of the conditions). In some embodiments, transaction service 106 can interact with blockchain 118 (e.g., as shown in FIG. 1B) to facilitate the creation of the smart contract and to execute the transaction using the smart contract. When transaction service 106 carries out the transaction without blockchain 118 (e.g., as in FIG. 1A), transaction service 106 can also be responsible for executing the smart contract.

When buyer 116 wishes to receive rights in the NFT, buyer 116 can interact with the NFT transfer platform 112. In some embodiments, depending upon the terms of the smart contract, buyer 116 may be entitled to receive a partial reveal of the NFT, where a portion of the NFT can be decrypted and provided for inspection by buyer 116.

In some embodiments, the NFT can be listed in an NFT marketplace or generally displayed on the Internet with one or more portions of the NFT being plainly visible, while other portions are obscured and/or encrypted. The encrypted NFT includes two parts, which include a visible part(s) of NFT (e.g., a partial reveal of the NFT) and a ciphertext that is the encryption of the NFT. The listing can be accompanied by a cryptographic authentication (e.g., the ciphertext) demonstrating that the displayed portions are part of the NFT. The cryptographic proof shows that the ciphertext is consistent with the revealed (e.g., visible) part(s) of the NFT.

When buyer 116 decides to go forward with a purchase by providing their public key, the smart contract associated with the NFT can utilize verification service 108 to cryptographically prove one or more terms of the transaction (e.g., to prove that the new encryption under the buyer's public key is consistent with the previous encryption, for the same plain NFT). For example, verification service 108 can prove that seller 114 has the decryption key for the NFT. In another example, verification service 108 can prove that a revealed portion of an NFT is part of the NFT in the transaction.

After the proofs required by the smart contract are satisfactorily proven, the smart contract can finish the transaction by exchanging value from buyer 116 to seller 114, and providing the NFT to buyer 116.

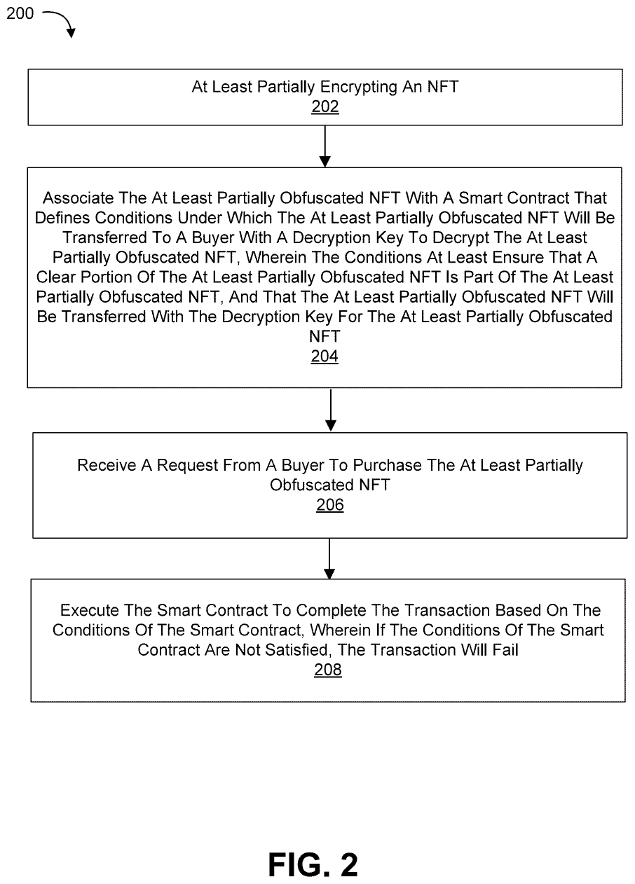

FIG. 2 illustrates an example high-level method for transferring ownership of an at least partially obfuscated NFT, in accordance with some aspects of the present technology. A partially obfuscated NFT can be an NFT where a portion of the NFT is viewable in the clear, while another portion of the NFT is encrypted or otherwise not viewable to non-rights holders.

In block 202, routine 200 at least partially encrypts (e.g., by using an NFT encryption service, such as NFT encryption service 104 of FIGS. 1A and 1B) an NFT to produce an at least partially obfuscated NFT. In block 204, routine 200 associates the at least partially obfuscated NFT with a smart contract (e.g., generated by a transaction service, such as transaction service 106 of FIGS. 1A and 1B) that defines conditions under which the at least partially obfuscated NFT will be transferred to a buyer (e.g., buyer 116 of FIGS. 1A and 1B) with a decryption key to decrypt the at least partially obfuscated NFT, wherein the conditions at least ensure that a clear portion of the at least partially obfuscated NFT is part of the at least partially obfuscated NFT, and that the at least partially obfuscated NFT will be transferred with the decryption key for the at least partially obfuscated NFT. In block 206, routine 200 receives a request from a buyer to purchase the at least partially obfuscated NFT. In block 208, routine 200 executes (e.g., by using a transaction service, such as transaction service 106 of FIGS. 1A and 1B) the smart contract to complete the transaction based on the conditions of the smart contract, wherein if the conditions of the smart contract are not satisfied, the transaction will fail.

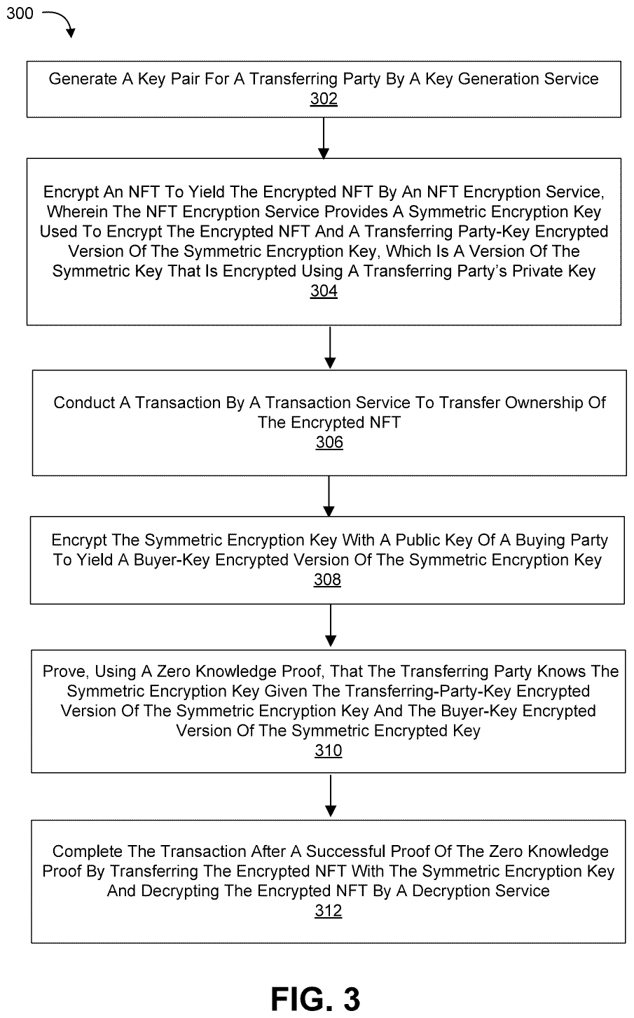

Similar to FIG. 2, FIG. 3 illustrates a method for transferring ownership of an encrypted NFT, except FIG. 3 employs the use of a zero-knowledge proof (ZKP) to prove the authenticity of the encrypted NFT. In particular, FIG. 3 illustrates an example high-level method for transferring ownership of an encrypted NFT using a zero-knowledge proof (ZKP) to prove the authenticity of the encrypted NFT, in accordance with some aspects of the present technology. In block 302, routine 300 generates a key pair for a transferring party (e.g., a seller, such as seller 114 of FIGS. 1A and 1B) by key generation service (e.g., key generation service 102 of FIGS. 1A and 1B). In block 304, routine 300 encrypts an NFT to yield the encrypted NFT by an NFT encryption service (e.g., NFT encryption service 104 of FIGS. 1A and 1B), wherein the NFT encryption service provides a symmetric encryption key used to encrypt the encrypted NFT, the encrypted NFT, and a transferring-party-key encrypted version of the symmetric encryption key, which is a version of the symmetric encryption key that is encrypted using a transferring party's private key. In block 306, routine 300 conducts a transaction by a transaction service (e.g., transaction service 106 of FIGS. 1A and 1B) to transfer the ownership of the encrypted NFT. In block 308, routine 300 encrypts the symmetric encryption key with a public key of a buying party (e.g., a buyer, such as buyer 116 of FIGS. 1A and 1B) to yield a buyer-key encrypted version of the symmetric encryption key. In block 310, routine 300 proves (e.g., by a verification service, such as verification service 108 of FIGS. 1A and 1B), using a zero-knowledge proof, that the transferring party knows the symmetric encryption key given the transferring-party-key encrypted version of the symmetric encryption key and the buyer-key encrypted version of the symmetric encryption key. In block 312, routine 300 completes the transaction after a successful proof of the zero-knowledge proof by transferring the encrypted NFT with the symmetric encryption key and decrypting the encrypted NFT by an NFT decryption service (e.g., NFT decryption service 110 of FIGS. 1A and 1B).

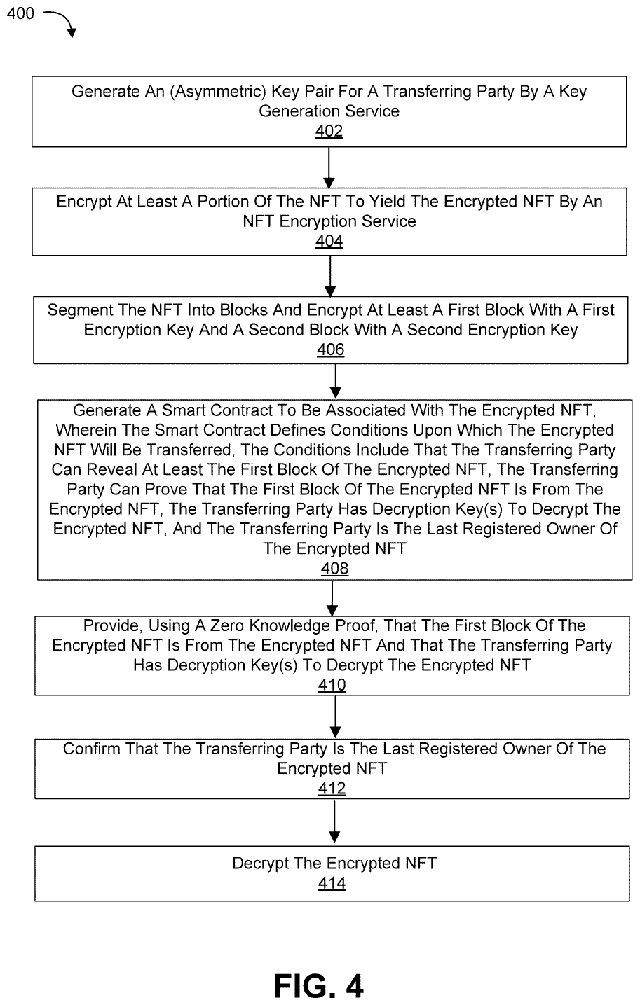

Similar to FIG. 2, FIG. 4 illustrates an example of a method for transferring ownership of a partially obfuscated NFT. In particular, FIG. 4 illustrates an example high-level method for transferring ownership of an encrypted NFT where a portion of the NFT is decrypted and revealed (e.g., which may be referred to as a “partial reveal”) prior to completing the transfer of the NFT, in accordance with some aspects of the present technology. In block 402, routine 400 generates a key pair (e.g., an asymmetric key pair) for a transferring party (e.g., a seller, such as seller 114 of FIGS. 1A and 1B) by a key generation service (e.g., key generation service 102 of FIGS. 1A and 1B). In block 404, routine 400 encrypts at least a portion of the NFT to yield the encrypted NFT (e.g., a partially revealed NFT) by an NFT encryption service (e.g., NFT encryption service 104 of FIGS. 1A and 1B), wherein the encrypting of at least a portion includes encrypting one or more portions, areas, and/or blocks of the NFT. In block 406, routine 400 segments the NFT into blocks and encrypts at least a first block with a first encryption key and a second block with a second encryption key. In block 408, routine 400 generates a smart contract (e.g., by using a transaction service, such as transaction service 106 of FIGS. 1A and 1B) to be associated with the encrypted NFT, wherein the smart contract defines conditions upon which the encrypted NFT will be transferred, the conditions include that the transferring party can reveal at least the first block of the encrypted NFT, the transferring party can prove that the first block of the encrypted NFT is from the encrypted NFT, the transferring party has decryption key(s) to decrypt the encrypted NFT, and the transferring party is the last registered owner of the encrypted NFT. In block 410, routine 400 provides, using a zero-knowledge proof, that the first block of the encrypted NFT is from the encrypted NFT and that the transferring party has decryption key(s) to decrypt the encrypted NFT. In block 412, routine 400 confirms (e.g., by using a verification service, such as verification service 108 of FIGS. 1A and 1B) that the transferring party is the last registered owner of the encrypted NFT. In block 414, routine 400 decrypts the encrypted NFT.

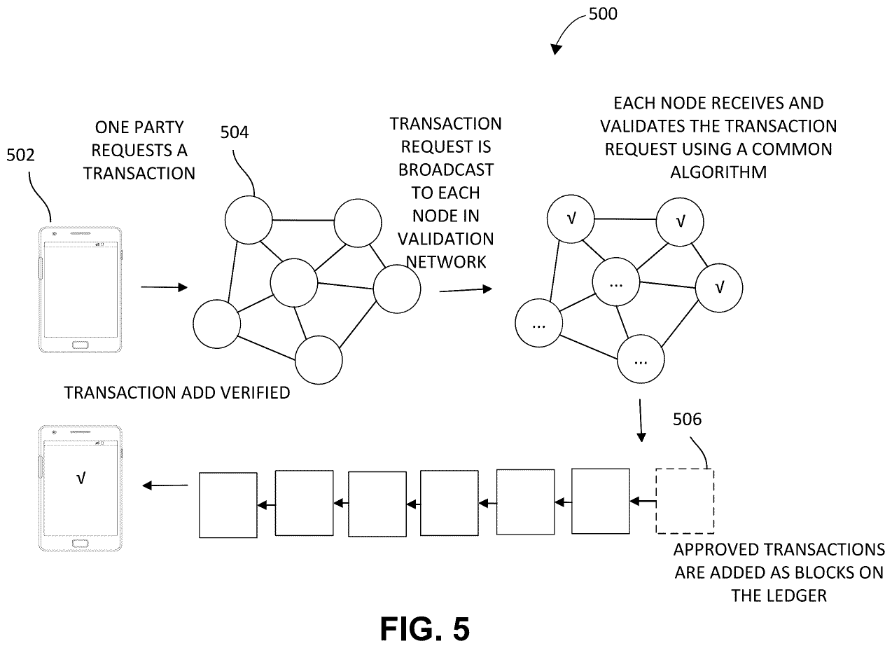

FIG. 5 illustrates an example blockchain transaction process 500, in accordance with some aspects of the present technology. Referring to FIG. 5, a blockchain is an ever-growing set of data blocks. Each block records a collection of transactions. Blockchains distribute these transactions across a group of computers. Each computer maintains its own copy of the blockchain transactions.

A blockchain is a continuously growing list of records, called blocks, which are linked and secured using cryptography. Each block typically comprises a cryptographic hash of the previous block, a timestamp, and transaction data. By design, a blockchain is resistant to modification of the data. Blockchains may implement an open, distributed ledger that can record transactions between two parties efficiently and in a verifiable and permanent way.

A blockchain is typically managed by multiple parties collectively adhering to a protocol for inter-node communication and validating new blocks. Once recorded, the data in any given block cannot be altered retroactively without alteration of all subsequent blocks, which requires consensus among the operators.

Cryptography involving mathematical methods of keeping data secret and proving identity is utilized when recording transactions. One digital key ensures only an owner can enter a transaction to the blockchain involving their assets, and another digital key lets other parties confirm it really was the owner who added the transaction.

Blockchain is resistant to tampering or other changes by utilizing a cryptographic technique called the hash. Hashing reduces data to a sequence of seemingly random characters—for example, the hash of the phrase “the quick brown fox” is “9ECB36561341D18EB65484E833EFEA61EDC74B84CF5E6AE1B81C63533E25FC8F” using a hash method of a SHA-256 algorithm. Other algorithms that may be employed for hashing include, but are not limited to, a Merkle-Damgard algorithm, a MD5 algorithm, a SHA-1 algorithm, a SHA-2 algorithm, a RACE Integrity Primitives Evaluation Message Digest-160 (RIP-EMD-160) algorithm, a Whirlpool algorithm, and a BLAKE2 algorithm. Tweaking just one letter in the phrase produces a completely different hash, and you cannot go backward to figure out the original data from the hash.

In FIG. 5, a user (e.g., an owner) associated with a computing device 502 (e.g., a mobile device, such as in the form of a smart phone) requests a blockchain transaction via the computing device 502. The transaction request from the user is broadcast to each node 504 within a verification network. Each of the nodes 504 in the verification network can receive and validate the transaction request from the user by using a common algorithm. After the nodes 504 validate the transaction request from the user, the approved transaction can be added as a block 506 on a distributed ledger in the form of a blockchain. After the block 506 is added to the blockchain, a verification of the transaction is sent to the user.

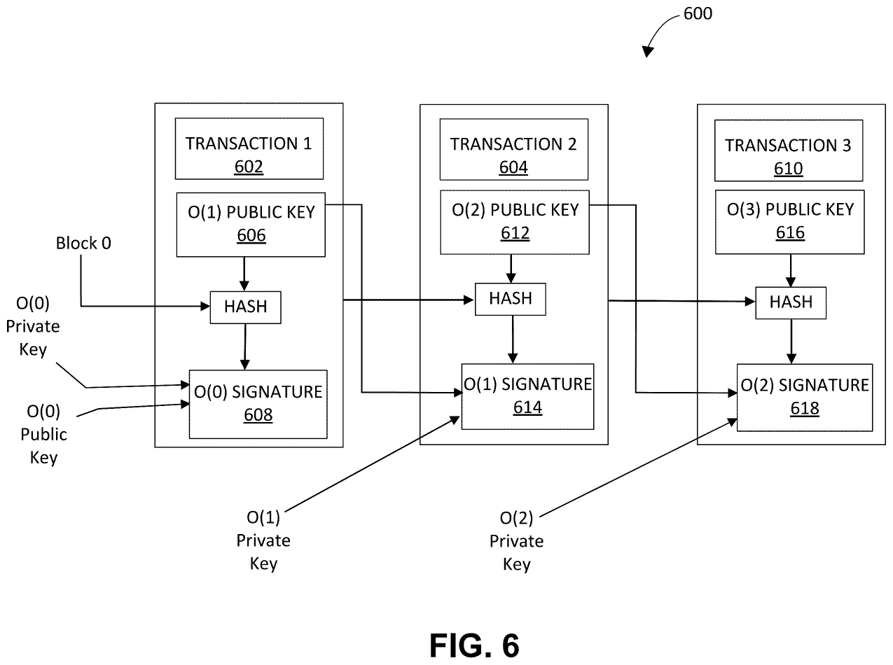

FIG. 6 illustrates an embodiment of an irreversible transaction blockchain 600, in accordance with some aspects of the present technology. The blockchain 600 is a sequence of digitally signed transactions (e.g., transaction 1 602, transaction 2 604, and transaction 3 610, etc.). Each transaction includes the current owners public key (e.g., block 1 owner public key 606, block 2 owner public key 612, and block 3 owner public key 616, respectively) and the previous owner's signature (e.g., O(0) signature 608, O(1) signature 614, and O(2) signature 618, respectively), which are generated using a hash function. The owner of a transaction can examine each previous transaction to verify the chain of ownership. Unlike traditional check endorsements, the transactions in the blockchain 600 are irreversible, which mitigates fraud.

As previously mentioned, in one or more aspects, the systems and techniques provide solutions for confidential NFTs. In one or more examples, the systems and techniques provide solutions for encrypted NFTs with a partial reveal. In one or more examples, the systems and techniques provide protocols for encrypted NFTs that do not require the use of specialized hardware (e.g., TEEs), and may be based only on the use of cryptographic primitives.

In one or more aspects, for the systems and techniques, the cryptographic primitives may be defined as follows. In one or more examples, a security parameter may be denoted by the variable κ. The symbol ← can denote the output of an algorithm, and the symbol ←$ can denote the output of a randomized algorithm.

In one or more examples, a pseudorandom function (PRF) family can be specified by efficient algorithms (PRF.KeyGen, PRF.Eval), where the algorithm PRF.KeyGen may be a randomized key generation algorithm that can take as an input a security parameter 1^{κ} and can output a random key K←K from key space K. The algorithm PRF.Eval may be a deterministic evaluation algorithm, which can take as an input a key K∈K and an input X in a domain {0, 1}^{l}, and can evaluate a function F_{K}(X) in a range R={0,1}^{μ}.

The systems and techniques can employ symmetric key encryption. In one or more examples, for the systems and techniques, a symmetric key encryption scheme can involve algorithms (SymEnc.KeyGen, SymEnc.Enc, SymEnc.Dec). The algorithm SymEnc.KeyGen can be a randomized key generation algorithm that can take as an input a security parameter 1^{κ}, and can output an encryption key k∈{0,1}^{κ}. The algorithm SymEnc.Enc can take as an input an encryption key k and a message m∈{0,1}^{polyκ}, and can output a ciphertext ct. The algorithm SymEnc.Dec can take as in input an encryption key k and a ciphertext ct, and can output a decrypted message m.

The systems and techniques can employ a public key encryption scheme. In one or more examples, for the systems and techniques, a public key encryption scheme can involve algorithms (PubEnc.KeyGen, PubEnc.Enc, PubEnc.Dec). The algorithm PubEnc.KeyGen can be a randomized key generation algorithm that can take as an input a security parameter 1^{κ}, and can output an encryption key pair (sk, pk). The algorithm PubEnc.Enc can take as an input a public key pk and a message m∈{0,1}^{poly(κ)}, and can output a ciphertext ct. The algorithm PubEnc.Dec can take as an input a secret key sk and a ciphertext ct, and can output the decrypted message m. Both types of encryption schemes (e.g., the symmetric key encryption and the public key encryption scheme) should satisfy correctness and indistinguishability under chosen plaintext attack (IND-CPA) security.

The systems and techniques can employ identity-based encryption (IBE). In one or more examples, for the systems and techniques, an IBE scheme can involve algorithms (IBE.KeyGen, IBE.Ext, IBE.Enc, IBE.Dec). The algorithm IBE.KeyGen can take as an input a security parameter 1^{κ}, and can output a master secret key msk and a public key pk. The algorithm IBE.Ext can take as an input pk, msk and an arbitrary identity id∈{0, 1}*, and can output an identity-based private key k. The algorithm IBE.Enc can take as an input pk, id and a message m∈{0,1}^{poly(κ)}, and can output a ciphertext ct. The algorithm IBE.Dec can take as an input pk, the identity-based private key k, and a ciphertext ct, and can output the decrypted message m. An IBE scheme should guarantee correctness and IND-ID-CPA security.

The systems and techniques can employ zero-knowledge proofs (ZKPs). In one or more examples, for the systems and techniques, ZKPs can allow a prover to convince a verifier that a statement is true. A ZKP scheme can involve algorithms (ZPK.Setup, ZPK.Prove, ZPK.Verify). The algorithm ZPK.Setup can be executed by a trusted entity or committee to generate public parameters param, the trapdoor of which will remain secret and discarded after the process. The algorithm ZPK.Prove can be executed by the prover. The algorithm ZPK.Prove can take as input parameters a statement x from language [symbol] and a secret witness w from the relation [symbol] (x), and can output a proof nt. The algorithm ZPK.Verify can be executed by the verifier. The algorithm ZPK.Verify can take as input parameters the statement x and proof π, and can output 1 if the proof is valid or output 0 otherwise. The ZKP schemes should support soundness and zero-knowledge. Non-interactive ZKPs, in particular (NIZKs), may be employed by the systems and techniques.

In one or more aspects, the systems and techniques provide definitions for the disclosed system, provide different workflows for the system that stem from the definitions, and provide descriptions of the different security properties for the system.

In one or more examples, an encrypted NFT (EncryptedNFT) system may be defined as a set of algorithms that are executed between an NFT creator C, a marketplace M, and users (e.g., buyers) Uᵢ. The algorithms may include, but are not limited to, a key generation algorithm KeyGen, an encryption of NFT algorithm EncNFT, a transaction mechanism TX, a verification mechanism VVerifyTX, and a decryption of NFT algorithm DecNFT. It can be assumed that an authenticated global ledger [symbol] exists. In one or more examples, given that the global ledger [symbol] is authenticated, all posted values will be signed by the sender (e.g., NFT creator).

In some examples, the key generation algorithm KeyGen (e.g., which may be performed by the key generation service 102 of FIGS. 1A and 1B) may be defined by: (sk, pk) [symbol] $ KeyGen(1^{κ}). Upon input of a security parameter, the key generation algorithm KKeyGen can create a secret key/public key pair (sk, pk). Conventionally, (sk₀, pk₀) can be used to denote the key pair for the NFT creator (e.g., who may also be viewed as the first owner of the NFT).

In one or more examples, the encryption of NFT algorithm EncNFT (e.g., which may be performed by the NFT encryption service 104 of FIGS. 1A and 1B) may be defined by: (msk, encKey₀, cNFT) [symbol] $ EncNFT(pk₀, NFT). The encryption of NFT algorithm EncNFT, upon input of the raw NFT and the public key of the NFT owner, can output a master secret key msk (e.g., which may be a persistent secret key for the lifetime of NFT), the encryption of msk under pk denoted by encKey₀, and the encryption of the NFT under msk denoted by cNFT.

In some examples, the transaction mechanism TX (e.g., which may be performed by the transaction service 106 of FIGS. 1A and 1B) may be defined by: (enckeyᵢ, π) [symbol] $ TX(skᵢ₋₁, encKeyᵢ₋₁, pkᵢ). The transaction mechanism TX is an algorithm that allows an NFT transaction from a current user (e.g., owner) Uᵢ₋₁ of an NFT to a next owner (e.g., buyer) Uᵢ of the NFT. When the transaction mechanism TX is executed by the current owner, the transaction mechanism TX can take as an input the current owner's secret key skᵢ₋₁, the encryption of a master secret key encKeyᵢ₋₁ (e.g., which can be decrypted under skᵢ₋₁), and the user buyer's public key pkᵢ. The transaction mechanism TX can output a encKeyᵢ, which is the NFT encryption key msk encrypted under pkᵢ, and a proof π which shows that the NFT encryption key is consistent.

In one or more examples, the verification mechanism VerifyTX (e.g., which may be performed by the verification service 108 of FIGS. 1A and 1B) may be defined by: {0,1}←VerifyTX(pkᵢ₋₁, pkᵢ, encKeyᵢ₋₁, encKeyᵢ, π). The verification mechanism VerifyTX is a verification function that can take as an input pkᵢ₋₁, pkᵢ, encKeyᵢ₋₁, encKeyᵢ, and π. The verification mechanism VerifyTX can return 1 if the proof is valid, or return 0 otherwise.

In some examples, the decryption of NFT algorithm DecNFT (e.g., which may be performed by the NFT decryption service 110 of FIGS. 1A and 1B) may be defined by: NFT←NFT←DecNFT(skᵢ, encKeyᵢ, cNFT). The decryption of NFT algorithm DecNFT is a decryption function that can take as an input the current owner's secret key skᵢ, the encrypted NFT encryption key encKeyᵢ, and the encrypted NFT, cNFT. The decryption of NFT algorithm DecNFT can output the plaintext NFT.

In one or more aspects, the systems and techniques provide a system (e.g., EncryptedNFT system) that provides a partial reveal feature that allows for a partial reveal of an NFT (e.g., to a potential buyer of that NFT). This partial reveal feature may be achieved by modifying the encryption of NFT algorithm EncNFT and by adding three additional algorithms.

In one or more examples, the encryption of NFT algorithm EncNFT (e.g., which may be performed by the NFT encryption service 104 of FIGS. 1A and 1B) may be modified to additionally take as an input a value m∈ [symbol] , which denotes the fractionalization of the NFT (e.g., this value will define the number of chunks or blocks that the NFT will be broken or divided into for the partial reveal of the NFT). In one or more examples, for simplicity purposes, it can be assumed that all m pieces of the NFT will be of equal size. However, different types of fractionalization of the NFT can also be supported. This modified encryption of NFT algorithm EncNFT can output auxiliary information aux that can be used for the partial reveal, and a proof πₐᵤₓ that can ensure the well formedness of the auxiliary information aux.

In some examples, a first additional algorithm (e.g., which may be performed in addition to the modified encryption of NFT algorithm EncNFT) is a verification mechanism VerifyAux (e.g., which may be performed by the verification service 108 of FIGS. 1A and 1B) and may be defined by: {0, 1}←VerifyAux(skᵢ; encKeyᵢ, NFT, m, aux, πₐᵤₓ). This verification mechanism VerifyAux is a verification function that can take as an input the current owner's secret key skᵢ, the encryption of the master secret key enckeyᵢ, the raw NFT, the fractionalization parameter m, the auxiliary data aux and the proof πₐᵤₓ, and can output a 1 if the proof verifies, or a 0 otherwise.

In one or more examples, a second additional algorithm (e.g., which may be performed in addition to the modified encryption of NFT algorithm EncNFT) is a partial reveal algorithm PartialReveal (e.g., which may be performed by the NFT encryption service 104 of FIGS. 1A and 1B) and may be defined by: (chunk, πₚ)←PartialReveal(skᵢ, encKeyᵢ, cNFT, aux, idx). This partial reveal algorithm PartialReveal can take as an input the current owner's secret key skᵢ, the encryption of the master secret key enckeyᵢ, the encrypted NFT cNFT, the partial reveal auxiliary information aux, and an index idx which denotes which part of the NFT will get revealed. The partial reveal algorithm PartialReveal can output the revealed part of the NFT chunk (or block) and a proof of consistency πₚ.

In some examples, a third additional algorithm (e.g., which may be performed in addition to the modified encryption of NFT algorithm EncNFT) is a partial verification mechanism PartialVerify (e.g., which may be performed by the verification service 108 of FIGS. 1A and 1B) and may be defined by: {0,1}←PartialVerify(pkᵢ, encKeyᵢ, cNFT, m, aux, idx, chunk, πₚ): This partial verification mechanism PartialVerify is a verification algorithm that can verify the partial reveal proof. The partial verification mechanism PartialVerify can output a 1, if the proof is valid, or can output a 0 otherwise. Depending upon the setting (e.g., and whether a chunk of the NFT becomes publicly known or not), this proof may be verifiable on the global ledger [symbol] or externally.

In one or more aspects, it can be assumed that a robust, censorship-resistant public ledger (e.g., the global ledger [symbol] ) exists to authenticate and document all of the pertinent NFT transactions. Given the application programming interface (API) as previously described, the values that can be posted on the global ledger [symbol] are described as follows. Firstly, it can be assumed that the encrypted NFT cNFT is posted on global ledger [symbol] by either the marketplace or by the NFT creator. In cases where a partial reveal is supported, aux and πₐᵤₓ may additionally be posted on the global ledger [symbol] . In some examples, the verification mechanism VerifyAux may be implemented as a smart contract on the global ledger [symbol] , in which case the verification mechanism VerifyAux will need to receive the encrypted NFT cNFT as an input. In one or more examples, when an NFT transaction occurs, the master secret key encKeyᵢ and proof it can be posted on the global ledger [symbol] . The posted transaction may also include all of the information and checks relevant to the underlying implementation of global ledger [symbol] , such as the total number of funds transmitted, the validity checks for sufficient funds, and double-spending, etc. These details are omitted from the discussion of the system simply for notational simplicity. The verification functions (VerifyAux and PartialVerify) can be executed by anyone, including a smart contract on a global ledger [symbol] . In one or more examples, if either of the verification functions (VerifyAux and PartialVerify) outputs a 0, the NFT transfer transaction should automatically fail and the funds (e.g., for purchasing the NFT) should be returned to the buyer.

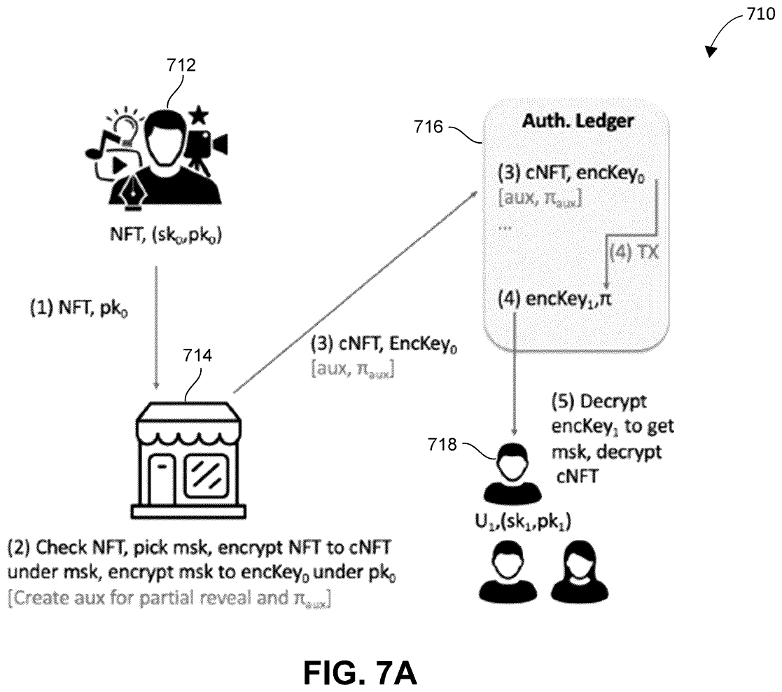

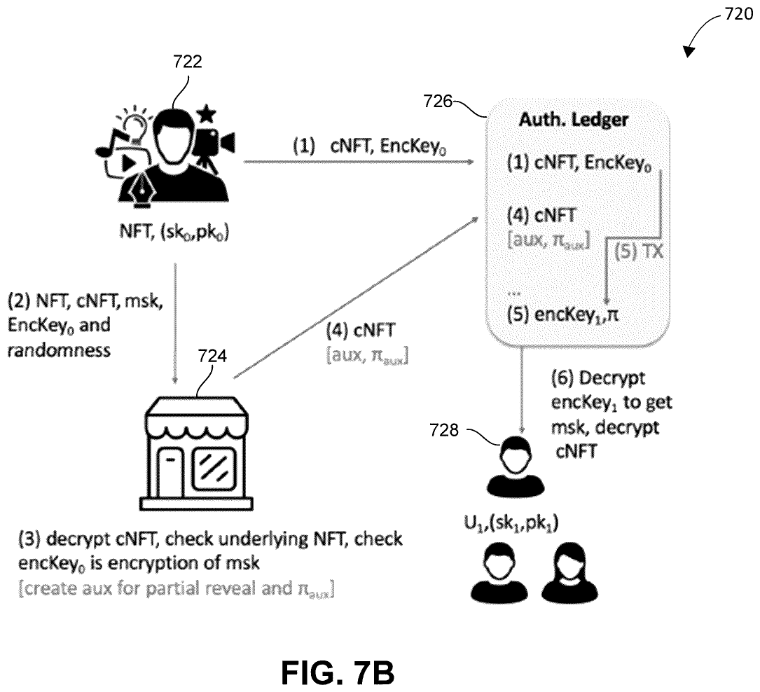

In one or more aspects, there are multiple options regarding who (e.g., person or entity) executes the EncNFT algorithm, depending upon the application. FIGS. 7A and 7B show two possible workflows between an NFT creator, a marketplace, an authenticated ledger, and a set of buyers. In both workflows, an important role of the marketplace is to check (e.g., verify) the NFT quality prior to posting any relevant message on the ledger. A reputable marketplace should not “approve” vacuous content and, as such, a posting by the marketplace can serve as a guarantee that the raw NFT is something meaningful (e.g., which can be even more important if a partial reveal of the NFT is not supported).

In particular, FIG. 7A is a diagram illustrating an example of a workflow 710 for transferring ownership of an encrypted NFT with a partial reveal, where a marketplace 714 encrypts the NFT with a partial reveal. In FIG. 7A, an NFT creator 712, the marketplace 714, a ledger 716, and a set of buyers 718 are shown. In one or more examples, the NFT creator 712 can completely outsource the execution of EncNFT to the marketplace 714. The marketplace 714 can be responsible for both creating and posting cNFT and encKey₀.

FIG. 7B is a diagram illustrating an example of a workflow 720 for transferring ownership of an encrypted NFT with a partial reveal, where a creator 722 encrypts the NFT with a partial reveal. In FIG. 7B, the NFT creator 722, a marketplace 724, a ledger 726, and a set of buyers 728 are shown. In one or more examples, the NFT creator 722 can execute the basic EncNFT on its own, and can post cNFT and encKey₀ to the ledger 726. The NFT creator 722 can then send all the relevant information to the marketplace 724. For this workflow 720, the role of the marketplace 724 is to check (e.g., verify) whether EncNFT was executed properly (e.g., and thus the need to receive the encryption randomness). If the check is verified by the marketplace 724, the marketplace 724 can make an additional post on the ledger 726 to indicate its “approval” of cNFT¹.

In both workflows 710, 720 of FIGS. 7A and 7B, the creator 712, 722 can maintain ownership of the NFT and is responsible for executing the first transaction with U₁. In both workflows 710, 720, if a partial reveal is supported, it can be assumed that the marketplace 714, 724 is the one creating and posting aux, πₐᵤₓ due to the higher computation costs. The creator 712, 722 (or any current owner of the NFT) can be able to check aux, πₐᵤₓ by running VerifyAux.

In one or more aspects, an encrypted NFT (EncryptedNFT) system should satisfy correctness, security, and privacy. In one or more examples, the security property of correctness may be defined as: if all entities are honest, the proofs should pass verification and the decrypted NFT should always match the original NFT.

In one or more examples, an encrypted NFT (EncryptedNFT) system satisfies correctness if for all NFT and n∈ [symbol] :

$$Pr [ \begin{matrix}∀ i ∈ [ 0 , n ] : ( {sk}_{i} , {pk}_{i} ) ← KeyGen ( {1}^{κ} ) \\ ( msk , {encKey}_{0} , cNFT ) ← EncNFT ( {pk}_{0} , NFT ) \\ ∀ i ∈ [ 1 , n ] : ( {encKey}_{i} , {π}_{i} ) ← TX ( {sk}_{i - 1} , {encKey}_{i - 1} , {pk}_{i} ) : \\ VerifyTX ( {pk}_{n - 1} , {pk}_{n} , {encKey}_{n - 1} , {encKey}_{n} , {π}_{n} ) = 1 \\ and DecNFT ( {sk}_{n} , {encKey}_{n} , CNFT ) = NFT\end{matrix} ] = 1$$

In one or more examples, if an encrypted NFT (EncryptedNFT) system is implemented to support a partial reveal, the system should also satisfy partial reveal correctness. In one or more examples, the security property of partial reveal correctness may be defined as: if all entities are honest, the proofs for partial reveal should pass verification and the partially revealed fractions should match the corresponding fractions of the original NFT.

In one or more examples, an encrypted NFT (EncryptedNFT) system satisfies partial reveal correctness if the system satisfies correctness and the following conditions are true. For all NFT, n∈ [symbol] , m∈ [symbol] and idx∈[1, m]:

$$Pr [ \begin{matrix}∀ i ∈ [ 0 , n ] , ( {sk}_{i} , {pk}_{i} ) ← KeyGen ( {1}^{κ} ) \\ ( msk , {encKey}_{0} , cNFT , aux , {π}_{aux} ) ← EncNFT ( {pk}_{0} , NFT , m ) \\ ∀ i ∈ [ 1 , n ] , ( {encKey}_{i} , {π}_{i} ) ← TX ( {sk}_{i - 1} , {encKey}_{i - 1} , {pk}_{i} ) \\ ( chunk ) , {π}_{p} ← PartialReveal ( {sk}_{i} , {encKey}_{n} , cNFT , idx ) : \\ chunk = NFT [ idx ] \\ and VerifyAux ( {sk}_{i} , {encKey}_{i} , NFT , m , aux , {π}_{aux} = 1 \\ and PartialVerify ( {pk}_{n} , {encKey}_{n} , cNFT , aux , idx , chunk , {π}_{p} ) = 1\end{matrix} ] = 1$$

In one or more examples, to define security, the system (e.g., the encrypted NFT (EncryptedNFT) system) may be envisioned as an interaction among the following entities: the NFT creator (e.g., seller) C, the marketplace M, and users (e.g., buyers) Uᵢ. In one or more examples, security should always be maintained against adversarial users during transactions and/or resells. However, there are four distinct scenarios (e.g., scenario 1, scenario 2, scenario 3, and scenario 4) regarding the behavior of the NFT creator and the marketplace.

In one or more examples, for scenario 1, both the NFT creator C and the marketplace M are honest. In this case, security for the EncryptedNFT will naturally rely on the underlying security of the transactions in [symbol] .

In some examples, for scenario 2, the NFT creator C is malicious, and the marketplace M is honest. Assuming either of the workflows presented in FIGS. 7A and 7B, an honest marketplace M should be able to detect malicious behavior by the NFT creator C and not “approve” the posted cNFT on the ledger.

In one or more examples, for scenario 3, the NET creator C is honest, and the marketplace M is malicious. Considering that the marketplace's main function is to alleviate computational burdens from NFT creators C and to streamline transaction processes with potential buyers, the case of an honest NFT creator C and a malicious marketplace M can be considered to be a natural case to capture the definitions that fall under this category of security.

In some examples, for scenario 4, both the NFT creator C and the marketplace M are malicious. This is the strongest scenario of the four scenarios.

In one or more examples, focusing on scenario 3, a formal experiment involving a challenger and an adversary can be defined. In this model, the challenger can represent the honest participants (e.g., the NFT creator and honest buyers), while the adversary can embody the potentially malicious marketplace and a set of malicious buyers. This framework can allow for a rigorous evaluation of the security of the system under realistic conditions, where the integrity of the NFT transfer is paramount, yet the trustworthiness of the marketplace is not assumed.

In one or more examples, a definition for a security property may be: an EncryptedNFT may be defined to be secure, if an adversary has a negligible advantage in winning a Security Game [symbol] (κ, NFT) with a challenger for all NFT. This definition captures the simple idea of security in the presence of a potentially adversarial marketplace M that prepares the encrypted NFT cNFT to alleviate the user from encryption computations. In one or more examples, this definition can guarantee that the first buyer of the NFT, defined by pk₁, will receive the correct NFT.

In some examples, an example of pseudocode for the Security Game [symbol] (κ, NFT) is as follows:

1. (sk₀, pk₀) ← KeyGen(1^{κ}), (sk₁, pk₁) ← KeyGen(1^{κ})
2. Send (NFT, pk₀, pk₁) to [symbol]
3. Receive (encKey ₀,cNFT,encKey₁, π) from [symbol]
4. Abort if DecNFT(sk₀, encKey₀,cNFT) ≠ NFT. [symbol] [symbol]
wins if: VerifyTX(pk₀, pk₁,encKey₀, encKey₁, π) = 1,
but DecNFT(sk₁, encKey₁,cNFT) ≠ NFT.

In some examples, a generalization of this definition for a security property may be provided that extends the security framework by allowing repeated reselling of the encrypted NFT in the secondary market. The goal of this definition is to protect the latest buyer, who may be presumed to be honest, even under the extreme assumption that all intermediate buyers (e.g., starting from the initial purchaser) may potentially act in an adversarial manner. This extended security model can be crucial for ensuring the integrity and trustworthiness of the NFT across multiple transactions and ownership transfers, safeguarding the interests of the final legitimate buyer against the complexities introduced by repeated resales and potentially untrustworthy intermediaries.

In one or more examples, a security property of resell security may be defined as: an EncryptedNFT may be defined to be resell secure, if an adversary has a negligible advantage in winning a Resell Security Game Resell [symbol] (κ, NFT) with a challenger for all NFT.

In some examples, an example of pseudocode for the Resell Security Game Resell [symbol] (κ, NFT) is as follows:

1. (sk₀, pk₀) ← KeyGen(1^{κ}),
(sk*, pk*) ← KeyGen(1^{κ})
2. Send (NFT, pk₀, pk*) to [symbol]
3. Receive (encKey₀,cNFT) from [symbol]
4. Abort if DecNFT(sk₀, encKey₀,cNFT) ≠ NFT.
5. Receive (pkᵢ, encKeyᵢ, πᵢ) from [symbol]
6. Abort if pkₙ ≠ pk* [symbol] [symbol]
wins if ∀i ∈ [1, n]: VerifyTX(pkᵢ₋₁, pkᵢ, encKeyᵢ₋₁, encKeyᵢ, πᵢ) = 1
but DecNFT (sk*, encKeyₙ, cNFT) ≠ NFT1

In one or more examples, security under partial reveal should additionally guarantee that an honest buyer running a partial reveal should receive the correct chunk (e.g., previously encrypted and/or obfuscated chunk) of the raw NFT.

In one or more examples, a security property of a partial revealer security may be defined as: an EncryptedNFT may be defined to be partial revealer secure, if an adversary has a negligible advantage in winning a Partial Revealer Security Game PartialRevSec_{A}(κ, NFT, m) for all NFT and m.

In some examples, an example of pseudocode for the Partial Revealer Security Game PartialRevSec_{A}(κ, NFT, m) is as follows:

```
1. (sk₀, pk₀) ← KeyGen(1^{κ}),
    (sk*, pk*) ← KeyGen(1^{κ})
2. Send (NFT, m, pk₀, pk*) to [symbol]
3. Receive (encKey₀,cNFT, aux, πₐᵤₓ) from [symbol]
4. Abort if DecNFT (sk₀, encKey₀,cNFT) ≠ NFT
    or if VerifyAux(skᵢ, encKeyᵢ, NFT, m, aux, πₐᵤₓ) = 0.
$5. Receive ( ( p {k}_{i} , encKe {y}_{i} , {π}_{l} ) \frac{n}{i = 1} idx , chunk , {π}_{p} ) from 𝒜$ [symbol]
wins if:
. ∀i ∈ [1, n]: VerifyTX(pkᵢ₋₁, pkᵢ, encKeyᵢ₋₁, encKeyᵢ, πᵢ) = 1,
  and PartialVerify (pk*, encKeyₙ, cNFT, m, aux, idx, chunk, πₚ) = 1,
  but DecNFT (sk*, encKeyₙ, cNFT) ≠ NFT or chunk ≠ NFT[idx]
```

In one or more examples, an example of pseudocode for Game ResellPrivacy_{A}(k) is as follows:

1. for i ∈ [0, n]: (skᵢ, pkᵢ) ← KeyGen(1^{k})
$2. Send {〈 {pk}_{1} 〉}_{i = 0}^{n} to 𝒜$
3. Receive (NFT₀, NFT₁) from [symbol]
4. Abort if NFT₀ ≠ NFT₁
5. Sample: bit b ← {0, 1}.
6. (msk, encKey₀,cNFT) ← EncNFT(sk₀, NFT_{b})
7. for i ∈ [1, n] : (encKey.πᵢ) ← TX(skᵢ₋₁, encKeyᵢ₋₁, pkᵢ)
$8. Send ( {encKey}_{0} , cNFT , {〈 encKe {y}_{i} , {π}_{i} 〉}_{i = 1}^{n} ) to 𝒜$
9. Receive b′ ← [symbol] [symbol] [symbol]
wins if b = b′

In one or more examples, the security games (e.g., including the Security Game Sec_{A}(κ, NFT), the Resell Security Game ResellSec_{A}(κ, NFT), and the Partial Revealer Security Game PartialRevSec_{A}(κ, NFT, m)) may be adapted to allow the adversary to select (sk₀, pk₀) instead, where (sk₀, pk₀) denotes the key pair for the NFT creator (e.g., who may also be viewed as the first owner of the NFT).

In one or more aspects, the systems and techniques can involve a number of privacy properties. In one or more examples, an encrypted NFT (EncryptedNFT) system should preserve the privacy of the NFT. However, this is subject to intrinsic limitations. The creator, the marketplace, and all buyers have access to the raw NFT. As a result, if any of them are dishonest, they could leak the raw NFT. As such, privacy can be ensured only for the case of an honest creator, an honest marketplace, and an honest buyer. If the marketplace cannot be trusted, the creator could themselves perform the encryption of the NFT and transfer the encrypted NFT to the buyer, while only tasking the marketplace to facilitate hosting, storage, and communication of the encrypted NFT. In one or more examples, the privacy property May be formally modeled as a semantic indistinguishability property. An adversary, upon reviewing a public transcript of all legitimate communications, will not be able to guess between two known and chosen NFTs underlying the transactions non-negligibly better than a random guess.

In one or more examples, a privacy property of a resell privacy may be defined as: an EncryptedNFT may be defined to be resell private, if an adversary has a negligible advantage over one-half (e.g., greater than fifty percent) in winning the ResellPrivac [symbol] (κ) game as previously described, for all n∈ [symbol] .

In one or more examples, in case a partial reveal is also supported, special care needs to be taken to guarantee privacy. The resell privacy definition can be extended by allowing the adversary to select two NFTs and a set of indices for a partial reveal, for which the content of the two NFTs will be identical. Then, a challenger can randomly pick one of the NFTs, and the resell privacy game can work similar as mentioned above, but also allowing the adversary to request partial reveals for the specified indices.

In one or more aspects, the systems and techniques can employ three different generic constructions (with and without a partial reveal) for NFT encryption. The three different constructions can include a zero knowledge proof (ZKP)-based construction without a partial reveal, a Merkle tree-based construction with a partial reveal, and an identity based encryption (IBE)-based construction with a partial reveal.

In one or more aspects, the systems and techniques provide a ZKP-based construction without employing a partial reveal. In one or more examples, ZKP is a method where a first party (e.g., the prover) can prove to a second party (e.g., the verifier) that a given statement is true, while avoiding conveying to the second party (e.g., the verifier) any information about the statement beyond the fact of the truth of the statement.

In one or more examples, this ZKP-based construction without a partial reveal involves encrypting an NFT using a symmetric encryption key msk. For transferring the NFT, the symmetric encryption key msk is transferred in its encrypted form on a public ledger (e.g., global ledger [symbol] ). For example, a creator can encrypt the symmetric encryption key msk under the creator's public key pk₀, and the creator can post it in its encrypted form on the global ledger [symbol] . To transfer the symmetric encryption key msk to a buyer with public key pk₁, the creator can encrypt the symmetric encryption key msk under pk₁ and transfer it in its encrypted form to the buyer. The creator can also transfer a zero knowledge proof that shows that the two encryptions of the symmetric encryption key msk are consistent under pk₀ and pk₁, respectively. The transaction can succeed, only if the zero knowledge proof is valid. The buyer can then decrypt the symmetric encryption key msk with his secret key sk₁, and further decrypt the NFT. Resales of the NFT may be performed in a similar way.

In some examples, an example of pseudocode for ZKP-based construction (without a partial reveal) is as follows:

```
Public Parameters:
            Public Key encryption scheme PubEnc,
            Symmetric Key encryption scheme SymEnc,
            and public parameters for ZKP.
Function KeyGen(1^{κ}):
            (sk, pk) ← PubEnc.KeyGen(1^{κ})
            Return (sk, pk)
Function EncNFT(pk₀, NFT):
              msk ← SymEnc.KeyGen(1^{κ})
              cNFT ← SymEnc.Enc(msk, NFT)
              encKey₀ ← PubEnc.Enc(pk₀, msk)
              Return (msk, encKeyₒ, cNFT)
Function TX(skᵢ₌₁, encKeyᵢ₌₁, Pkᵢ₌₁):
              msk ← PubEnc.Dec(skᵢ₌₁, encKeyᵢ₌₁)
  encKeyᵢ ← PubEnc.Enc(pk₁,msk)
                π ← ZKP.Prove{(pkᵢ₌₁·pkᵢ·encKeyᵢ₌₁·encKeyᵢ) |
                      ∃ msk, skᵢ₌₁, r₁, r₂ :
                      (skᵢ₌₁, pkᵢ₌₁) = PubEnc.KenGen(1^{κ}, r₁)Λ
                msk = PubEnc.Dec(skᵢ₌₁, encKeyᵢ₌₁)Λ
                encKeyᵢ = PubEnc.Enc(pkᵢ,msk, r₂)}
                  Return (encKeyᵢ, π)
Function VerifyTX(pkᵢ₌₁, pkᵢ, encKeyᵢ₌₁, encKeyᵢ, π):
                    Return ZKP.Verify{π, (pkᵢ₌₁, pkᵢ, encKeyᵢ₌₁, encKeyᵢ) |
        ∃ msk, skᵢ₌₁, r₁, r₂ :
                        (sk_{I=1}, pk_{I=1}) = PubEnc.KeyGen(1^{κ}, r₁) Λ
    msk = PubEnc.Dec(skᵢ₌₁, encKeyᵢ₌₁) Λ
                        encKeyᵢ = PubEnc.Enc(pkᵢ, msk, r₂)}
Function DecNFT(skᵢ, encKeyᵢ,cNFT):
          msk←PubEnc.Dec(skᵢ, encKeyᵢ)
      NFT←SymEnc.Dec(msk, cNFT)
                        Return NFT
```

In one or more examples, an example of pseudocode for Schnoor instantiation is as follows:

```
Public Parameters:
    Group G of prime order q, group generator g,
    and collision-resistant hash function [symbol] .
Function KeyGen(1^{κ}):
    sk ← [symbol] _{q}, pk ← g^{sk}
    Return (sk, pk)
Function EncNFT(pk₀, NFT):
    msk ← G
    cNFT ← SymEnc.Enc(msk, NFT)
  r ← [symbol]  _{q}, EncKey₀ ← (pk₀, g^{r} , msk · pk₀^{r})
    Return (msk, encKeyₒ, cNFT)
Function TX(skᵢ₌₁, encKeyᵢ₌₁, Pkᵢ₌₁):
    (a, b, c) ← encKeyᵢ₌₁ (msk ← c · b^{-sk}^{ᵢ₌₁})
  r ← [symbol]  _{q}, encKey ← (pkᵢ, g^{r}, msk · pkᵢ^{r})
    α, β ← [symbol]  _{q}
    u₁ ← g^{α}, u₂ ← g^{β}, v ← b^{α} · pkᵢ^{-β}
  h ← [symbol] (encKey^{ᵢ₌₁} ||encKeyᵢ||u₁|| u₂||υ)
    s₁ ← sk^{ᵢ₌₁} · h + α, s₂ ← r · h + β
      π ← (s₁, s₂, u₁, u₂, υ)
        Return (encKeyᵢ, π)
Function VerifyTX (pk^{ᵢ₌₁}, pkᵢ, encKey^{ᵢ₌₁}, encKeyᵢ, π):
  (a₁, b₁, c₁) ← encKeyᵢ₌₁, (a₂, b₂, c₂) ← encKeyᵢ,
    (s₁, s₂, u₁, u₂, υ) ← π
        Assert a₁ = pkᵢ₌₁ and a₂ = pkᵢ
      h ← [symbol]  (encKeyᵢ₌₁||encKeyᵢ||u₁|| u₂||υ)
  $Return {g}^{{s}_{1}} = {a}_{1}^{h} \cdot {u}_{1} and {g}^{{s}_{2}} = {b}_{2}^{h} \cdot {u}_{2}$
        $and {b}_{1}^{{2}_{1}} \cdot {a}_{2}^{- {s}_{2}} = {( {c}_{1} \cdot {c}_{2}^{- 1} )}^{h} \cdot v$
Function DecNFT(skᵢ, encKeyᵢ,cNFT):
      (a, b, c) ← encKeyᵢ, msk← c · b^{-sk}^{ᵢ}
    NFT ← SymEnc.Dec(msk, cNFT)
        Return NFT
```

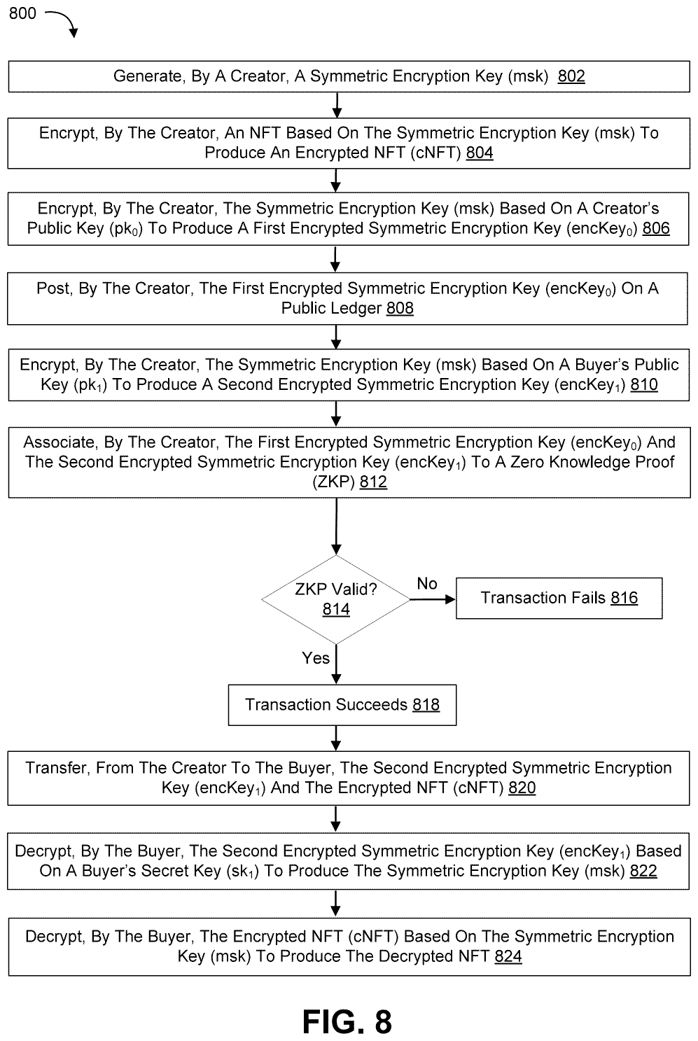

FIG. 8 illustrates an example process 800 for transferring ownership of an encrypted NFT (without a partial reveal) using a zero-knowledge proof to prove the authenticity of the encrypted NFT, in accordance with some aspects of the present technology. In FIG. 8, during operation of the process 800, at block 802, a creator (e.g., a seller or transferring party) of an NFT, may generate (e.g., by using a key generation service, such as the key generation service 102 of FIGS. 1A and 1B) a symmetric encryption key (msk). At block 804, the creator may encrypt (e.g., by using an NFT encryption service, such as the NFT encryption service 104 of FIGS. 1A and 1B) the NFT based on (e.g., using) the symmetric encryption key (msk) to produce an encrypted NFT (cNFT).

In one or more examples, a transaction to transfer ownership of the encrypted NFT from the creator (e.g., transferring party) to a buyer may be conducted. For the transaction, at block 806, the creator may encrypt the symmetric encryption key (msk) based on (e.g., using) a public key (pk₀) associated with the creator to produce a first encrypted symmetric encryption key (encKey₀). At block 808, the creator may post the first encrypted symmetric encryption key (encKey₀) on a public ledger (e.g., global ledger [symbol] ). At block 810, the creator can encrypt the symmetric encryption key (msk) based on (e.g., using) a public key (pk₁) associated with a buyer of the NFT to produce a second encrypted symmetric encryption key (encKey₁). At block 812, the creator can associate the first encrypted symmetric encryption key (encKey₀) and the second encrypted symmetric encryption key (encKey₁) with a zero knowledge proof (ZKP). The zero knowledge proof can show (e.g., prove) that the two encryptions of the symmetric encryption key (msk) are consistent under the public key (pk₀) associated with the creator and the public key (pk₁) associated with a buyer, respectively. The zero knowledge proof, when proven to be valid, can indicate that transferring party knows the symmetric encryption key (msk) given the encryption of the symmetric encryption key (msk) to produce the first encrypted symmetric encryption key (encKey₀) is consistent with the public key (pk₀), and given the encryption of the symmetric encryption key (msk) to produce second encrypted symmetric encryption key (encKey₁) is consistent with the public key (pk₁).

After the first encrypted symmetric encryption key (encKey₀) and the second encrypted symmetric encryption key (encKey₁) are associated with the zero knowledge proof, at decision block 814, it can be determined (e.g., by a transaction service, such as the transaction service 106 of FIGS. 1A and 1B) whether the zero knowledge proof is valid. If it is determined that the zero knowledge proof is not valid (e.g., No), the process 800 can proceed to block 816, where the NFT transaction fails.

However, if it is determined that the zero knowledge proof is valid (e.g., Yes), the process 800 can proceed to block 818, where the NFT transaction succeeds. Upon success of the NFT transaction, at block 820, the second encrypted symmetric encryption key (encKey₁) and the encrypted NFT (cNFT) can be transferred from the creator (e.g., seller) to the buyer.

After receiving the second encrypted symmetric encryption key (encKey₁) and the encrypted NFT (cNFT), at block 822, the buyer can decrypt the second encrypted symmetric encryption key (encKey₁) based on (e.g., using) a private key (sk₁) associated with the buyer to produce the symmetric encryption key (msk). After producing the symmetric encryption key (msk), at block 824, the buyer can decrypt (e.g., by using an NFT decryption service, such as the NFT decryption service 110 of FIGS. 1A and 1B) the encrypted NFT (cNFT) based on (e.g., using) the symmetric encryption key (msk) to produce the decrypted NFT.

In one or more aspects, the systems and techniques provide solutions for NFTs with a partial reveal. In one or more examples, for a partial reveal, an NFT creator (e.g., seller) may want to expose one or more small parts of an NFT on an NFT marketplace to show potential buyers features of the NFT and to make a claim that the creator owns that particular NFT. Since the creator shows only a partial reveal of the NFT on the NFT marketplace, the creator is able to maintain exclusivity of the whole NFT for himself.

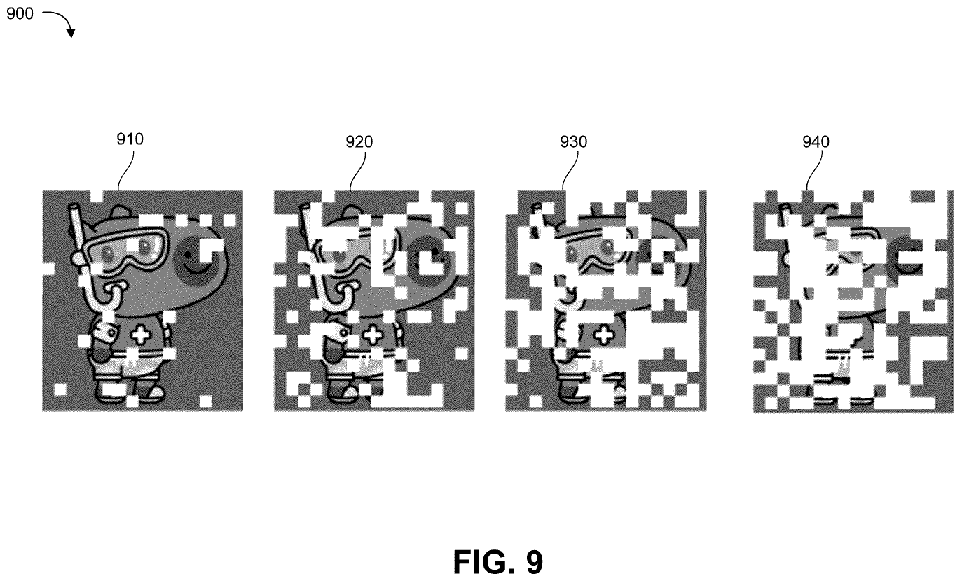

FIG. 9 illustrates examples 900 of partial reveals 910, 920, 930, 940 of an NFT with different degrees (or levels) of obfuscation, in accordance with some aspects of the present technology. In one or more examples, FIG. 9 shows a partial reveal 910 of an NFT with an obfuscation degree of ten percent (%), a partial reveal 920 of an NFT with an obfuscation degree of thirty-three %, a partial reveal 930 of an NFT with an obfuscation degree of fifty %, and a partial reveal 940 of an NFT with an obfuscation degree of seventy-five %.

In one or more examples, a Merkle tree-based construction or an identity based encryption (IBE)-based construction may be employed for achieving a partial reveal of an NFT. These two constructions provide the capability for a creator to specify parts of an NFT to be revealed to potential buyers as well as for the creator to prove on a blockchain that the partial reveal of the NFT belongs to the original NFT (e.g., the creator has a legitimate claim of ownership of the original NFT, and the creator is not just showing a random image that has no connection with the encrypted NFT).

In one or more examples, for the Merkle tree-based construction, the original unencrypted NFT can be broken down into parts (or blocks). The creator can select one or more parts (or blocks) of an original unencrypted NFT to be obfuscated from the view of potential buyers. Each part (or block) of the selected one or more parts (or blocks) may be encrypted by performing a respective cryptographic hash on that part (or block) to produce an encrypted part (or block). For example, a first block of the original unencrypted NFT may be encrypted by performing a first cryptographic hash of the first block to produce a first encrypted block. For another example, a second block of the original unencrypted NFT may be encrypted by performing a second cryptographic hash of the second block to produce a second encrypted block. Each leaf (e.g., node) of the Merkle tree has a respective cryptographic hash for each of the parts (or blocks) of the NFT. The root of the Merkle tree has a root cryptographic hash that may be used to decrypt all of the encrypted parts (or blocks) of the NFT. A hash tree can allow for an efficient and secure verification of the contents of the NFT. The hash tree is a generalization of a hash list that is used for encrypting the parts (or blocks) of the NFT.

In one or more examples, the systems and techniques can employ an EncryptedNFT construction with partial reveal based on Merkle trees. Assuming that a fractionalization factor is m, the high level idea for a partial reveal is to encrypt each of the m fractions of the NFT with a different SymEnc key kᵢ, store all kᵢ's for i∈[m] in a Merkle tree, and publish the tree root rt. To partially reveal the NFT in a position idx, the current owner can decrypt that fraction of the NFT, and return the decrypted fraction, the decryption key in that index k_{idx}, and also provide a proof that k_{idx} is in the Merkle tree.

In some examples, an example of pseudocode for a Merkle tree-based construction for a partial reveal of an NFT is as follows:

```
Public Parameters:
  Collision-resistant hash function [symbol]    .
  Pseudo-random function PRF.
  Public Key encryption scheme PubEnc.
  Symmetric Key encryption scheme SymEnc.
  Public parameters for ZKP.
Function KeyGen(1^{κ}):
  (skᵢ, pkᵢ) ←$ PubEnc.KeyGen(1κ)
  Return (skᵢ, pkᵢ)
Function EncNFT(pk₀, NFT, [n]):
  mskₐᵤₓ ←$ PRF.KeyGen(1^{κ})
  msk_{full} ←$ SymEnc.KeyGen(1^{κ})
  cNFT ←$ SymEnc.Enc(msk_{full},NFT)
  For i ∈ [m]:
    kᵢ = PRF.Eval(msk_{full}, i)
    cNFTₐᵤₓ[i] ←$ SymEnc.Enc(kᵢ,NFT[i])
  Build a Merkle Tree with kᵢ for i ∈ [m] as leaves.
  Let rt be the root of the tree.
  encKey _{0,aux} ←$ PubEnc.Enc(pk₀, mskₐᵤₓ)
  encKey _{0, full}←$ PubEnc.Enc(pk₀, msk_{full})
  encKey₀ ←$ (encKey_{o,aux}, encKey_{0,full})
  aux ← (rt, cNFTₐᵤₓ), πₐᵤₓ ←⊥
  Return (msk_{full}, encKey₀,cNFT,aux, πₐᵤₓ)
Function VerifyAux(skᵢ, encKeyᵢ, NFT, m, aux, πₐᵤₓ):
  Parse aux as (rt, cNFTₐᵤₓ)
  Parse encKeyᵢ as (encKey_{i,aux}, encKey_{i,full})
  mskₐᵤₓ ← PubEnc.Dec(skᵢ, encKey_{i,aux})
  For i ∈ [m]:
    kᵢ = PRF.Eval(mskₐᵤₓ, i)
    Assert SymEnc.Dec(kᵢ,cNFT[i]) = NFT[i]
  Build a Merkle Tree with kᵢ for i ∈ [m] as leaves.
  Let rt′ be the root of the tree.
  Assert rt = rt′.
Function TX(skᵢ₋₁, encKeyᵢ₋₁, pkᵢ):
  mskₐᵤₓ ← PubEnc.Dec(skᵢ₋₁, encKey_{i-1,aux})
  msk_{full} ← PubEnc.Dec(skᵢ₋₁, encKey_{i-1,full})
  encKey_{i, aux} ←$ PubEnc.Enc(pkᵢ, mskₐᵤₓ)
  encKey _{i,full} ←$ PubEnc.Enc(pkᵢ, msk_{full})
  π ←$ ZKP.Prove{(pkᵢ₋₁, pkᵢ, encKey_{i,aux}, encKey_{i,full}) |
    ∃mskₐᵤₓ, msk_{full}, skᵢ₋₁, r : ∀j ∈ {aux, full} :
    mskⱼ = PubEnc.Dec(skᵢ₋₁, encKey_{i-1,j})
    Λ encKey_{i,j} = PubEnc.Enc(pkᵢ, mskⱼ, r)}
  encKeyᵢ ← (encKey_{i,aux}, encKey_{i,full})
  Return (encKey_{I}, π)
Function VerifyTX(pkᵢ₌₁, pkᵢ, encKeyᵢ₌₁, encKeyᵢ, π):
  Assert ZKP.verify(π, (pkᵢ₋₁, pkᵢ, encKeyᵢ₋₁, encKeyᵢ))
Function DecNFT(skᵢ, encKeyᵢ, cNFT):
  msk_{full} ← PubEnc.Dec(skᵢ, encKey_{i,full}),
  NFT← SymEnc.Dec(msk_{full}, cNFT)
  Return NFT
Function PartialReveal(skᵢ, encKeyᵢ, cNFT, m, aux, idx):
  Parse encKeyᵢ as (encKey_{i,aux}, encKey_{i,full})
  mskₐᵤₓ ← PubEnc.Dec(skᵢ, encKey_{i,aux})
  For i = 1 to m : kᵢ ← PRF.Eval(mskₐᵤₓ, i)
  Build a Merkle Tree with kᵢ for i ∈ [m] as leaves.
  Let rt be the root of the tree.
  Let πₚ be k_{idx} along with its Merkle authentication path to rt.
  NFT_{idx} ← SymEnc.Dec(k_{idx}, cNFTₐᵤₓ[idx])
  Return (NFT_{idx}, πₚ)
Function PartialVerify(pkᵢ, encKeyᵢ, cNFT, m, aux, idx, NFT_{idx}, πₚ):
  Parse aux as (rt, cNFTₐᵤₓ)
  Parse πₚ as k_{idx} along with its
  Merkle authentication path to rt.
  Assert correctness of the Merkle authentication path.
  Assert NFT_{idx} = SymEnc.Dec(k_{idx},cNFT[idx])
```

In one or more examples, identity based encryption (IBE) is a type of public-key encryption where a public key of a user includes some unique information (e.g., biometric information, such as a fingerprint, or personal identifiable information (PII), such as a name or an email address) associated with the identity of the user. For the IBE-based construction, a sender (e.g., an NFT creator), who has access to the public parameters of the NFT transfer system (e.g., NFT transfer platform, such as the NFT transform platform 112 of FIGS. 1A and 1B), can encrypt a part (or block) of the NFT based on (e.g., by using) some unique identifiable information (e.g., email address) as a key. A receiver (e.g., a buyer) may obtain a decryption key from a central authority, which should be trusted as the central authority generates secret keys for every user of the NFT system.

In some examples, the systems and techniques provide a strong notion of security, which is non-equivocation. The systems and techniques can realize this property of non-equivocation by leveraging IBEs. In one or more examples, the Merkle-tree based construction, can also support non-equivocation if the EncNFT algorithm is extended to also provide a ZKP showing that the partial reveal information has been setup correctly.

In one or more examples, non-equivocation can guarantee that even if both the creator and the marketplace are adversarial, honest buyers can receive the same version of the decrypted NFT. In order to model this scenario, a security game in which a challenger acts as two honest buyers among a sequence of transactions can be considered. The adversary can generate the encrypted NFT and the public keys for the rest of the accounts involved in the NFT transfers. As long as all of the transactions are successful (e.g., pass the VerifyTX verification), the challenger can receive consistent NFTs.

In one or more examples, for non-equivocation, a new NFT verification function VerifyNFT can be used to replace VerifyAux. The VerifyNFT function can take as an input the creator's public key pk₀, the encryption of the master secret key denoted encKey₀, the encryption of the NFT cNFT, and the proof π_{NFT}, and can return 1 if the encryptions are consistent or 0 otherwise. The VerifyNFT function differs from the VerifyAux function in that it does not take any secret key or the original NFT as input and, as such, it can be executed by anyone with public information. We give the formal definition below and also extend it to the partial reveal scenario.

In one or more examples, an EncryptedNFT can be defined to be non-equivocable if an adversary has a negligible advantage in winning the NonEqui [symbol] (κ) game. In some examples, an example of pseudocode for the NonEqui [symbol] (κ) game is as follows:

```
$1. ( {sk}_{0}^{*} , {pk}_{0}^{*} ) ← K e y G e n ( {1}^{κ} ) , ( s {k}_{1}^{*} , {pk}_{1}^{*} ) ← K e y G e n ( {1}^{κ} )$
$2. Send ( {pk}_{0}^{*} , {pk}_{1}^{*} ) to 𝒜$
3. Receive (cNFT, π_{NFT}, pk₀, encKey₀) and
    ${〈 {pk}_{i} , {encKey}_{i} , {π}_{i} 〉}_{i = 1}^{{n}_{1}} from 𝒜$
4. Abort if pkₙ_{₁} ≠ pk*₀
5. Abort if VerifyNFT (pk₀, encKey₀, cNFT, π_{NFT}) = 0
$6. Receive ( b , {〈 {pk}_{i} , e n c K e {y}_{i} , {π}_{i} 〉}_{i = {n}_{1} + 1}^{{n}_{2}} from 𝒜$
7. Abort if b ∉ {0, 1} or pkₙ_{₂} ≠ pk*_{b}
$8. {NFT}_{0} ← D ecNFT ( s {k}_{0}^{*} , encKe {y}_{{n}_{1}} , cNFT ) ,$
    ${NFT}_{1} ← D ecNFT ( s {k}_{b}^{*} , encKe {y}_{{n}_{2}} , cNFT )$ [symbol] [symbol]
    wins if:
∀i ∈ [1, n₂], VerifyTX(pkᵢ₋₁ pkᵢ, encKeyᵢ₋₁, encKeyᵢ, πᵢ) = 1,
but NFT₀ ≠ NFT₁.
```

In one or more examples, an EncryptedNFT with partial reveal can be defined to be non-equivocable if an adversary has a negligible advantage in winning the PartialRevNonEqui [symbol] (κ) game. In some examples, an example of pseudocode for the PartialRevNonEqui [symbol] (κ) game is as follows:

```
$1. ( {sk}_{0}^{*} , {pk}_{0}^{*} ← KeyGe n ( {1}^{κ} ) , ( s {k}_{1}^{*} , {pk}_{1}^{*} ) ← K e y G e n ( {1}^{κ} )$
$2. Send ( {pk}_{0}^{*} , {pk}_{1}^{*} ) to 𝒜$
3. Receive (m,cNFT, π_{NFT}, pk₀, encKey₀) and
    ${〈 {pk}_{i} , {encKey}_{i} , {π}_{i} 〉}_{i = 1}^{{n}_{1}} from 𝒜$
$4. Abort if {pk}_{{n}_{1}} \neq {pk}_{0}^{*}$
5. Abort if VerifyNFT(pk₀, encKey₀, cNFT, π_{NFT}) = 0
$6. Receive 〈 b , {〈 {pk}_{i} , e n c K e {y}_{i} , {π}_{i} 〉}_{i = {n}_{1} + 1}^{{n}_{2}}$
    and (idx, chunk, πₚ, chunk′, π′_{y}) from [symbol]
$7. Abort if b ∉ \{ 0 , 1 \} or {pk}_{{n}_{2}} \neq {pk}_{b}^{*}$
$8. {NFT}_{0} ← D ecNFT ( s {k}_{0}^{*} , encKe {y}_{{n}_{1}} , cNFT ) ,$
    ${NFT}_{1} ← D ecNFT ( s {k}_{b}^{*} , encKe {y}_{{n}_{2}} , cNFT )$ [symbol] [symbol]
    wins if:
∀i ∈ [1, n₂], VerifyTX(pkᵢ₌₁ pkᵢ, encKeyᵢ₌₁, encKeyᵢ, πᵢ) = 1, and
$PartialVerify ( {pk}_{0}^{*} , {encKey}_{{n}_{1}} , cNFT , idx , chunk , {π}_{p} ) = 1 , and$
$PartialVerify ( {pk}_{b}^{*} , e n c K e {y}_{{n}_{2}} , cNFT , idx , {chunk}^{′} , {π}_{p}^{′} = 1 ,$
but NFT₀ ≠ NFT₁ or chunk ≠ NFT₀ [idx] or chunk′ ≠ NFT₁ [idx].
```

In one or more examples, the systems and techniques can provide an IBE-based construction that achieves non-equivocation, together with an instantiation based on an adaption of the IBE scheme. The basic idea is to treat the index of each portion of the NFT as the identity such that each portion can be independently encrypted by a SymEnc key, and the SymEnc key can be further encrypted by the sub-key derived from IBE.Ext. For a partial reveal, the SymEnc key can be revealed without harming the privacy of other parts of the NFT.

In some examples, an example of pseudocode for an IBE-based construction for a partial reveal of an NFT is as follows:

```
Public Parameters:
  Public Key encryption scheme PubEnc,
  Symmetric Key encryption scheme SymEnc,
  public parameters for ZKP,
  and Identity-based encryption scheme IBE.
Function KeyGen(1^{κ}):
  (sk, pk) ← PubEnc.KeyGen(1^{κ})
  Return (sk, pk)
Function EncNFT (pk₀, NFT, m):
  (msk, pk) ← IBE.KeyGen(1^{κ})
  encKey₀ ← PubEnc. Enc(pk₀, msk)
  πₘₛₖ ← ZKP.Prove{(pk, pk₀, encKey₀) | ∃msk, r₁, r₂:
  (msk, pk) = IBE.KeyGen(1^{κ}, r₁) ∧
  encKey₀ = PubEnc. Enc(pk₀, msk, r₂)}
  For idx ∈ [m]:
  subKey_{idx} ← SymEnc. KeyGen(1^{κ} )
  cNFT_{idx} ← SymEnc.Enc(subKey_{idx}, NFT_{idx})
  encSubK_{idx} ← IBE.Enc(pk, idx, subKey_{idx})
  π_{idx} ← ZKP.Prove{(pk, idx, encSubK_{idx}) | ∃msk, subKey_{idx}, r₁, r₂:
    (msk, pk) = IBE.KeyGen(1^{κ}, r₁) ∧
    encSubK_{idx} ← IBE.Enc(pk, idx, subKey_{idx}, r₂)}
  $cNFT ← {〈 c N F {T}_{i d x} , e n c S u b {K}_{i d x} 〉}_{i d x = 1}^{m}$
  $Return ( msk , {encKey}_{0} , cNFT , {π}_{N F T} = ( pk , {π}_{m s k} , {〈 {π}_{i d x} 〉}_{i d x = 1}^{m} ) )$
Function VerifyNFT(pk₀, encKey₀, cNFT, π_{NFT}):
  ${〈 c N F {T}_{i d x} , e n c S u b {K}_{i d x} 〉}_{i d x = 1}^{m} ← cNFT$
  $( pk , {π}_{msk} , {〈 {π}_{i d x} 〉}_{i d x = 1}^{m} ) ← {π}_{N F T}$
  Assert ZKP.Verify (πₘₛₖ, (pk, pk₀, encKey₀))
  For idx ∈ [m]:
  Assert ZKP.Verify (π_{idx}, (pk, idx, encSubK_{idx}))
Function TX(skᵢ₌₁, enckeyᵢ₌₁, pkᵢ):
  msk ← PubEnc. Dec(skᵢ₌₁, encKeyᵢ₌₁)
  encKeyᵢ ← PubEnc.Enc(pkᵢ, msk)
  π ← ZKP. Prove{(pkᵢ₌₁, pkᵢ, encKeyᵢ₌₁, encKeyᵢ)|
    ∃msk, skᵢ₌₁, r₁, r₂:
    (skᵢ₌₁, pkᵢ₌₁) = PubEnc.KeyGen(1^{κ}, r₁) ∧
    msk = PubEnc. Dec(skᵢ₌₁, encKeyᵢ₌₁) ∧
    encKeyᵢ = PubEnc. Enc(pkᵢ, msk, r₂)}
  Return (encKeyᵢ, π)
Function VerifyTX (pkᵢ₌₁, pkᵢ, enckeyᵢ₌₁, encKeyᵢ, π):
  Return ZKP.Verify (π, (pkᵢ₌₁, pkᵢ, encKeyᵢ₌₁ encKeyᵢ))
Function DecNFT (skᵢ, encKeyᵢ, cNFT):
  msk ← PubEnc. Dec(skᵢ, encKeyᵢ)
  ${〈 cNF {T}_{i d x} , e n c S u b {K}_{i d x} 〉}_{i d x = 1}^{m} ← cNFT$
For idx ∈ [m]:
    subKey: ← IBE.Dec(IBE.Ext(msk, idx), encSubK_{idx})
    NFT_{idx} ← SymEnc.Dec( subKey_{idx}, cNFT_{idx})
  Return NFT
Function PartialReveal (skᵢ, encKeyᵢ, cNFT, idx):
  msk ← PubEnc. Dec(skᵢ, encKeyᵢ)
  ${〈 cNF {T}_{i d x} , e n c S u b {K}_{i d x} 〉}_{i d x = 1}^{m} ← cNFT$
  subKey_{idx} ← IBE.Dec(IBE.Ext(msk, idx), encSubK_{idx})
  π ← ZKP.Prove{(encKeyᵢ, encSubK_{idx}, subKey_{idx})| ∃msk, skᵢ :
    msk = PubEnc. Dec(skᵢ, encKeyᵢ)∧
    subKey_{idx} = IBE.Dec(IBE.Ext(msk, idx), encSubK_{idx})}
  NFT_{idx} ← SymDec(subKey_{idx}, cNFT_{idx})
  Return (NFT_{idx}, πₚ = (subKey_{idx}, π):
Function PartialVerify (pkᵢ, encKeyᵢ, cNFT, idx, NFT_{idx}, πₚ):
  (subKey_{idx}, π) ← πₚ
```

In one or more examples, an example of pseudocode for a pairing-based instantiation is as follows:

```
Public Parameters:
  Asymmetric bilinear group G₁ × G₂ → G_{T} of prime order q, group
  generator
  g ∈ G₂, collision-resistant hash function [symbol] .
  and Identity-based encryption scheme IBE.
Function KeyGen(1^{κ}):
  sk ← [symbol]  _{q}, pk ← g^{sk}
  Return (sk, pk)
Function EncNFT(pk₀, NFT, m):
  g₁ ← G₁, g₂ + ← G₂, α ← [symbol]  _{q}, h ← g₁^{α},
  msk ← g₂^{α}, pk ← (g₁, g_{2,} h)
  $r ← {ℤ}_{q} , {encKey}_{0} ← ( p {k}_{0} , {g}_{2}^{r} , msk \cdot {pk}_{0}^{r} )$
  $β , γ ← {ℤ}_{q} , u ← {g}_{1}^{β} , v ← {g}_{2}^{γ} , w ← {g}_{2}^{β} \cdot {pk}_{0}^{γ}$
  j ← H(pk||pk₀||encKey₀||u||v||w)
  s₁ ← α · j + β, s₂ ← r · j + γ
  πₘₛₖ ← (u, v, w, s₁, s₂)
  For idx ∈ [m]:
    subKey_{idx} ← G_{T}, cNFT_{idx} < ← SymEnc(subKey_{idx}, NFT_{idx})
    s ← [symbol]  _{q}, encSubK_{idx} ← (subKey_{idx} · e(h, g₂)^{s} , g₁^{s}, H(idx)^{s})
    π_{idx} ← ⊥
  $cNFT ← {〈 c N F {T}_{i d x} , e n c S u b {K}_{i d x} 〉}_{i d x = 1}^{m}$
  $Return ( msk , {encKey}_{0} , cNFT , {π}_{N F T} = ( pk , {π}_{m s k} , {〈 {π}_{i d x} 〉}_{i d x = 1}^{m} ) )$
Function VerifyNFT(pk₀, encKey₀, cNFT, π_{NFT}):
  ${〈 c N F {T}_{i d x} , e n c S u b {K}_{i d x} 〉}_{i dx = 1}^{m} ← cNFT$
  $( pk , {π}_{msk} , {〈 {π}_{i d x} 〉}_{i d x = 1}^{m} ) ← {π}_{N F T}$
  (a, b, c) ← encKey₀, (u, v, w, s₁, s₂) ← πₘₛₖ
  j ← H(pk||pk₀||encKey₀||u||v||w)
  $Assert {g}_{1}^{{s}_{1}} = {h}^{j} \cdot u ∧ {g}_{2}^{{s}_{2}} = {b}^{j} \cdot v ∧ {g}_{2}^{{s}_{1}} . {pk}_{0}^{{s}_{2}} = {c}^{j} \cdot w$
  For idx ∈ [m]:
    (a′, b′, c′) ← encSubK_{idx}
    Assert e(b′, H(idx)) = e(g₁,c′)
Function TX(skᵢ₌₁, encKeyᵢ₌₁, pk₁):
  (a, b, c) ← encKeyᵢ₌₁ msk ← c · b^{=sk}^{ᵢ₌₁}
  $r ← {ℤ}_{q} , e n c K e {y}_{i} ← ( {pk}_{i} , {g}_{2}^{r} , msk \cdot {pk}_{i}^{r} )$
  $α , β ← {ℤ}_{q} , {u}_{1} ← {g}_{2}^{α} , {u}_{2} ← {g}_{2}^{β} , v ← {b}^{α} \cdot {pk}_{i}^{= β}$
  j ← H(encKeyᵢ₌₁||encKeyᵢ||u₁||u₂||v)
  s₁ ← skᵢ₌₁ · j + α, s₂ ← r · j + β, π ← (s₁, s₂, u₁, u₂, v)
  Return (encKeyᵢ, π)
Function VerifyTX (pkᵢ₌₁, pkᵢ, encKeyᵢ₌₁, encKeyᵢ, π):
  (a₁, b₁, c₁) ← encKeyᵢ₌₁, (a₂, b₂, c₂) ← encKeyᵢ
  Assert a₁ = pkᵢ₌₁ and a₂ = pkᵢ
  (s₁, s₂, u, v, w) ← π, j ←H(encKeyᵢ₌₁||encKeyᵢ||u||v||w)
  $Return {g}_{2}^{{s}_{1}} = {a}_{1}^{j} \cdot u and {g}_{2}^{{s}_{2}} = {b}_{2}^{j} \cdot v$
    $and {b}_{1}^{{s}_{1}} \cdot {a}_{2}^{= {s}_{2}} = {( {c}_{1} \cdot {c}_{2}^{= 1} )}^{j} \cdot w$
Function DecNFT (skᵢ, encKeyᵢ, cNFT):
  $( a , b , c ) ← e n c K e {y}_{i} , m s k ← c \cdot {b}^{= s {k}_{i}} , {〈 c N F {T}_{i d x} , e n c S u b {K}_{i d x} 〉}_{i d x = 1}^{m} ← cNFT$
  For idx ∈ [m]:
    (a′, b′, c′) ← encSubK_{idx}, subKey_{idx} ← a′/e (b′, msk)
    NFT_{idx} ← SymDec(subKey_{idx}, cNFT_{idx})
  $Return {〈 {NFT}_{i d x} 〉}_{i d x = 1}^{m}$
Function PartialReveal (skᵢ, encKeyᵢ, cNFT, idx):
  (a, b, c) ← encKeyᵢ, msk ← c · b^{=sk}^{ᵢ}, r ← [symbol]  _{q}, πₚ ← (msk · H(idx)^{r}, g₁^{r})
  ${〈 cNF {T}_{i d x} , e n c S u b {K}_{i d x} 〉}_{i d x = 1}^{m} ← cNFT$
  (a′, b′, c′) ← encSubK_{idx}, subKey_{idx} ← a′/e (b′, msk)
  NFT_{idx} ← SymDec(subKey_{idx}, cNFT_{idx})
  Return (NFT_{idx}, πₚ = π)
Function PartialVerify (pkᵢ, encKeyᵢ, cNFT, idx, NFT_{idx}, πₚ):
  ${〈 c N F {T}_{i d x} , e n c S u b {K}_{i d x} 〉}_{i d x = 1}^{m} ← cNFT , ( a , b ) ← π$
  (a′, b′, c′) ← encSubK_{idx}, subKey_{idx} ← a′ · e(b, c′)/e(b′, a)
```

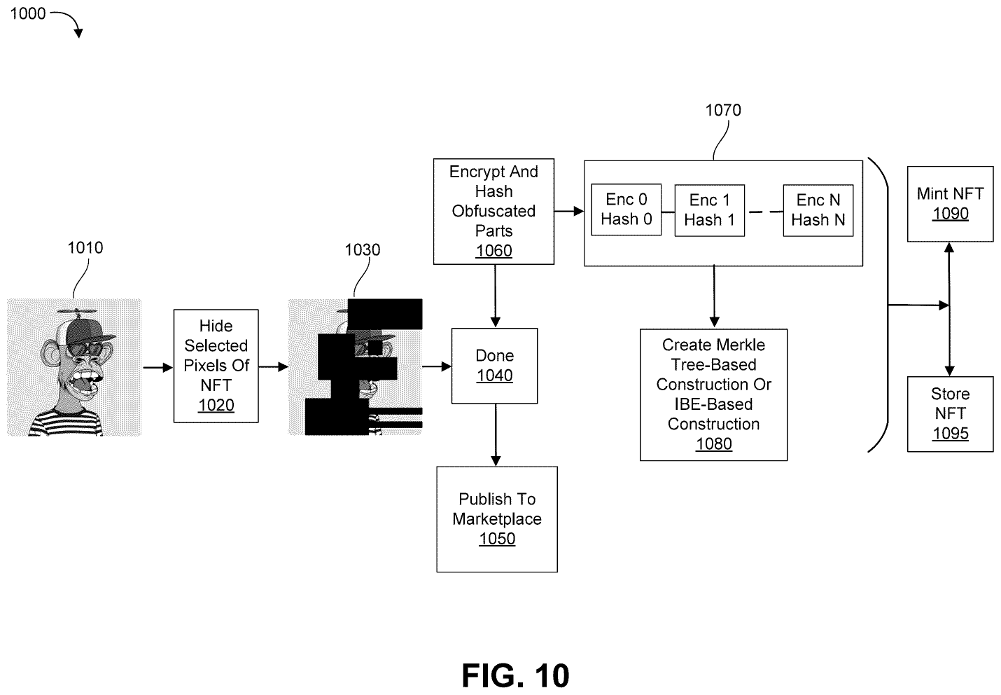

FIG. 10 illustrates an example of a process 1000 for generating an NFT with a partial reveal, in accordance with some aspects of the present technology. In FIG. 10, during the operation of the process 1000, a creator can create an NFT 1010 (e.g., an original unencrypted NFT). The creator can then, at block 1020, divide the NFT 1010 into a plurality of parts or blocks (e.g., including pixels), and can select one or more parts or blocks of the plurality of parts or blocks of the NFT 1010 to hide (or obfuscate) from potential buyers of the NFT 1010 to produce an obfuscated NFT 1030. In FIG. 10, the obfuscated NFT 1030 shows the selected parts (or blocks) of the NFT being obscured or concealed from view. After the obfuscated NFT 1030 has been created (or is done, at block 1040), at block 1050, the obfuscated NFT 1030 can be published on an NFT marketplace (e.g., an NFT website) for potential buyers to view the obfuscated NFT 1030 to determine whether to purchase the NFT 1010 (e.g., original unencrypted NFT) from the creator.

Also, after the obfuscated NFT 1030 has been created (or is done, at block 1040), at blocks 1060 and 1070, each obscured part (or block) of the obfuscated NFT 1030 can be encrypted by performing a respective cryptographic hash on that part (or block) to produce an encrypted part (or block). For example, a first block may be encrypted by performing a first cryptographic hash (e.g., Hash 0) of the first block to produce a first encrypted block (e.g., Enc 0). For another example, a second block may be encrypted by performing a second cryptographic hash (e.g., Hash 1) of the second block to produce a second encrypted block (e.g., Enc 1).

In one or more examples, the obfuscated NFT is the partially encrypted NFT, where partially encrypting the NFT 1010 involves encrypting one or more blocks of the NFT 1010 with a respective cryptographic hash.

In one or more examples, at block 1080, a Merkle-tree based construction or an IBE-based construction can be created for the partial reveal. For example, for a Merkle tree-based construction for the partial reveal, the Merkle tree can include a plurality of leaves (e.g., nodes) on branches of the tree and can include a root at the base of the tree. Each leaf (e.g., node) of the Merkle tree can have a respective cryptographic hash for each of the parts (or blocks) of the NFT 1010. The root of the Merkle tree can have a root cryptographic hash that may be used (e.g., is capable) to decrypt all of the encrypted parts (or blocks) to produce a decrypted NFT 1010. For example, for an IBE-based construction for the partial reveal, each of the cryptographic hashes for the blocks may be based on a respective key that is based on some unique identifiable information (e.g., email address) associated with the creator of the NFT 1010. In one or more examples, the IBE-based construction may follow a similar tree construction as the Merkle tree.

After the selected blocks have been encrypted to produce encrypted blocks (e.g., Enc 0, Enc 1, . . . . Enc N), at block 1090, the obfuscated NFT 1030 can be minted. In some examples, at block 1095, the obfuscated NFT 1030 along with the encrypted blocks (e.g., Enc 0, Enc 1, . . . . Enc N) may be stored in memory, which can include coordinates (e.g., (x1, y1), (x2, y2), . . . (xN, yN)) for each of the encrypted blocks.

In one or more examples, The obfuscated NFT 1030 may be associated with smart contract that defines conditions under which the obfuscated NFT 1030 can be transferred to a buyer with a decryption key to decrypt the obfuscated NFT 1030. The conditions can ensure that a clear portion (e.g., one or more blocks that are viewable by the buyer prior to the purchase) of the obfuscated NFT 1030 is part of the obfuscated NFT 1030, and that the obfuscated NFT 1030 will be transferred (e.g., to the buyer) with the decryption key for the obfuscated NFT 1030. In some examples, the decryption key may include a root cryptographic hash. In one or more examples, a request may be received (e.g., by a transaction service, such as the transaction service 106 of FIGS. 1A and 1B) from a buyer to purchase the obfuscated NFT 1030. The smart contract may be executed (e.g., by the transaction service), based on receiving the request from the buyer, to complete the transaction based on the conditions of the smart contract (e.g., the conditions of the smart contract being met). When the conditions of the smart contract are not satisfied, the transaction will fail.

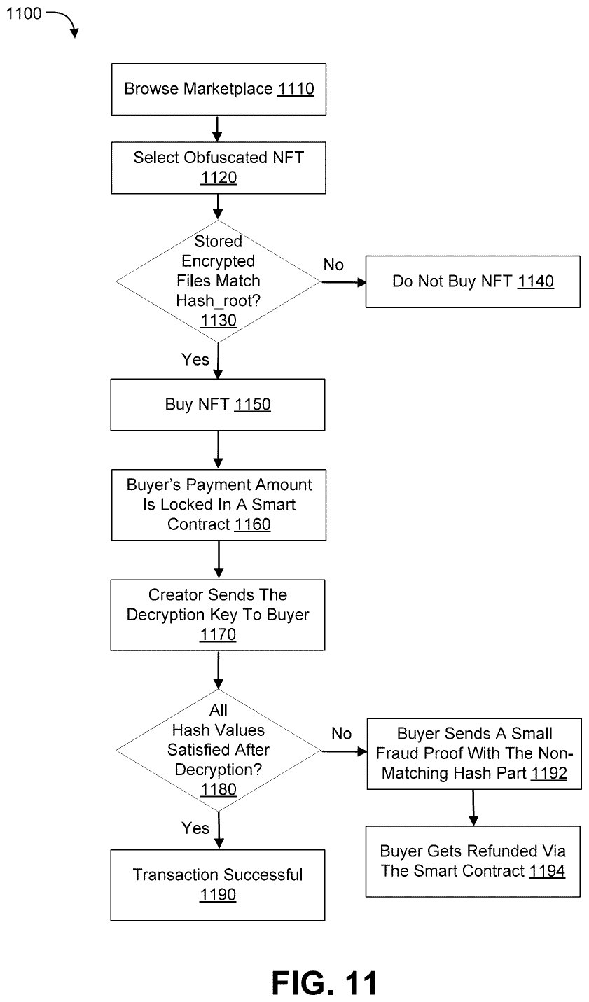

FIG. 11 illustrates an example of a process 1100 for a buyer to prove and purchase an NFT with a partial reveal, in accordance with some aspects of the present technology. In FIG. 11, during operation of the process 1100, at block 1110, a buyer (e.g., collector) may browse an NFT marketplace (e.g., an NFT website). At block 1120, the buyer may select an obfuscated NFT (e.g., obfuscated NFT 1030 of FIG. 10) from the NFT marketplace to purchase its associated original unencrypted NFT (e.g., NFT 1010 of FIG. 10). At decision block 1130, the buyer can determine whether stored encrypted files (e.g., of the encrypted blocks of the obfuscated NFT) match the hash root (e.g., hash_root, such as in the case of a Merkle tree-based construction for a partial reveal). If the buyer determines that the stored encrypted files do not match the hash root (e.g., No), the process 1110 can proceed to block 1140 and the buyer does not purchase the NFT.

However, if the buyer determines that the stored encrypted files do not match the hash root (e.g., Yes), the process 1110 can proceed to block 1150 and the buyer can proceed to purchase the NFT from a creator (e.g., seller) of the NFT. For the purchase of the NFT by the buyer, at block 1160, the buyer's payment amount for the NFT can be locked within a smart contract for the purchase of the NFT from the creator of the NFT. After the payment amount is locked within the smart contract for the purchase of the NFT, at block 1170, the creator can send a decryption key for the NFT to the buyer.

After receiving the decryption key from the creator, the buyer can decrypt (or attempt to decrypt) all of the obfuscated blocks of the NFT (e.g., the obfuscated NFT). After decrypting (or attempting to decrypt) all of the obfuscated blocks, at decision block 1180, the buyer can determine whether the hash values for the blocks are satisfied after the decryption. If the buyer determines that not all of the hash values for the blocks are satisfied after the decryption (e.g., No), the process 1100 can proceed to block 1192 and the buyer can send a small fraud proof with the non-matching hash parts or blocks to the creator and/or a transaction service (e.g., transaction service 106 of FIGS. 1A and 1B). The fraud proof can indicate the one or more hash values associated with one or more blocks that are not satisfied after decryption of the obfuscated blocks of the NFT (e.g., the obfuscated NFT). Based on receiving (e.g., by creator and/or the transaction service) the fraud proof, the transaction will fail and, at block 1194, the buyer can receive a refund for the purchase amount via the smart contract.

However, if the buyer determines that all of the hash values for the blocks are satisfied after the decryption (e.g., Yes), the process 1100 can proceed to block 1190 and the transaction is successful. At block 1190, the buyer has successfully purchased the NFT from the creator via the smart contract (e.g., where the buyer is able to successfully recreate the NFT by using the coordinates for the obfuscated blocks), and the creator can claim the payment amount for the sale of the NFT from the smart contract.

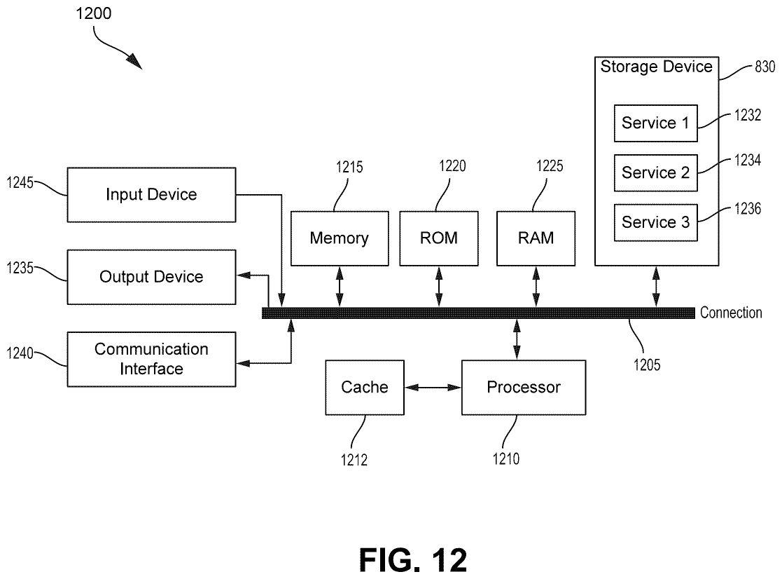

FIG. 12 is a block diagram illustrating an example of a computing system 1200, which may be employed for confidential NFTs. In particular, FIG. 12 illustrates an example of computing system 1200, which can be for example any computing device making up the NFT platform, internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200.

Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1240 may also include one or more range sensors (e.g., LiDAR sensors, laser range finders, RF radars, ultrasonic sensors, and infrared (IR) sensors) configured to collect data and provide measurements to processor 1210, whereby processor 1210 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for transferring ownership of an at least partially obfuscated NFT, the method comprising:
at least partially encrypting an NFT to produce the at least partially obfuscated NFT;
associating the at least partially obfuscated NFT with a smart contract that defines conditions under which the at least partially obfuscated NFT will be transferred to a buyer with a decryption key to decrypt the at least partially obfuscated NFT,
wherein the conditions ensure that a clear portion of the at least partially obfuscated NFT is part of the at least partially obfuscated NFT, and that the at least partially obfuscated NFT will be transferred with the decryption key for the at least partially obfuscated NFT;
receiving a request from a buyer to purchase the at least partially obfuscated NFT; and
executing, based on receiving the request from the buyer, the smart contract to complete the transaction based on the conditions of the smart contract.

2. The method of claim 1, further comprising dividing the NFT into a plurality of blocks.

3. The method of claim 2, wherein at least partially encrypting the NFT comprises encrypting one or more blocks of the plurality of blocks with a respective cryptographic hash.

4. The method of claim 3, further comprising creating a construction comprising the one or more respective cryptographic hashes.

5. The method of claim 4, wherein the construction comprises one or more nodes, and wherein each node of the one or more nodes comprises the one or more respective cryptographic hashes.

6. The method of claim 4, wherein the construction comprises a root, wherein the root comprises a root cryptographic hash, and wherein the root cryptographic hash is capable of decrypting the at least partially obfuscated NFT to produce the NFT.

7. The method of claim 6, wherein the decryption key comprises the root cryptographic hash.

8. The method of claim 3, further comprising receiving a fraud proof from the buyer indicating that one or more respective hash values associated with the one or more blocks are not satisfied after decryption of the at least partially obfuscated NFT.

9. The method of claim 8, wherein based on receiving the fraud proof, the transaction will fail.

10. The method of claim 4, wherein the construction is a Merkle tree-based construction or an identity based encryption-based construction.

11. The method of claim 10, wherein when the construction is an identity based encryption-based construction, each cryptographic hash of the one or more respective cryptographic hashes is based on unique identifiable information associated with a creator of the NFT.

12. The method of claim 11, wherein the unique identifiable information comprises at least one of biometric information or personal identifiable information.

13. The method of claim 1, further comprising publishing the at least partially obfuscated NFT on an NFT marketplace.

14. The method of claim 1, wherein if the conditions of the smart contract are not satisfied, the transaction will fail.

15. A method of transferring ownership of an encrypted NFT using a zero knowledge proof to prove authenticity of the encrypted NFT, the method comprising:
encrypting, based on a symmetric encryption key for a transferring party, an NFT to produce the encrypted NFT; and
conducting a transaction to transfer the ownership of the encrypted NFT from the transferring party to a buyer, wherein the transaction comprises:
encrypting, based on a first public key associated with the transferring party of the NFT, the symmetric encryption key to produce a first encrypted symmetric encryption key;
encrypting, based on a second public key associated with the buyer of the NFT, the symmetric encryption key to produce a second encrypted symmetric encryption key;
proving a zero knowledge proof is valid, wherein the zero knowledge proof indicates that the transferring party knows the symmetric encryption key given the encryption of the symmetric encryption key to produce the first encrypted symmetric encryption key is consistent with the first public key and given the encryption of the symmetric encryption key to produce the second encrypted symmetric encryption key is consistent with the second public key; and
completing, based on the zero knowledge proof being valid, the transaction by transferring to the buyer the encrypted NFT and the second encrypted symmetric encryption key.

16. The method of claim 15, further comprising generating, by a key generation service, the symmetric encryption key for the transferring party.

17. The method of claim 15, wherein encrypting the NFT to produce the encrypted NFT is performed by an NFT encryption service.

18. The method of claim 15, further comprising posting the first encrypted symmetric encryption key on a public ledger.

19. The method of claim 18, wherein the public ledger is a global ledger.

20. The method of claim 15, further comprising associating the first encrypted symmetric encryption key and the second encrypted symmetric encryption key to the zero knowledge proof.
